SEQUENCE LISTING (119 sequences)

SEQ ID NO: 1 - DNA, 2859 bp, Homo sapiens
ctttccgcggcattctttgggcgtgagtcatgcaggtttgcagccagccccaaagggggtgtgtgcgcgagcagagcgctataaatacggcgcctcccagtgcccacaacgcggcgtcgccaggaggagcgcgcgggcacagggtgccgctgaccgaggcgtgcaaagactccagaattggaggcatgatgaagactctgctgctgtttgtggggctgctgctgacctgggagagtgggcaggtcctgggggaccagacggtctcagacaatgagctccaggaaatgtccaatcagggaagtaagtacgtcaataaggaaattcaaaatgctgtcaacggggtgaaacagataaagactctcatagaaaaaacaaacgaagagcgcaagacactgctcagcaacctagaagaagccaagaagaagaaagaggatgccctaaatgagaccagggaatcagagacaaagctgaaggagctcccaggagtgtgcaatgagaccatgatggccctctgggaagagtgtaagccctgcctgaaacagacctgcatgaagttctacgcacgcgtctgcagaagtggctcaggcctggttggccgccagcttgaggagttcctgaaccagagctcgcccttctacttctggatgaatggtgaccgcatcgactccctgctggagaacgaccggcagcagacgcacatgctggatgtcatgcaggaccacttcagccgcgcgtccagcatcatagacgagctcttccaggacaggttcttcacccgggagccccaggatacctaccactacctgcccttcagcctgccccaccggaggcctcacttcttctttcccaagtcccgcatcgtccgcagcttgatgcccttctctccgtacgagcccctgaacttccacgccatgttccagcccttccttgagatgatacacgaggctcagcaggccatggacatccacttccatagcccggccttccagcacccgccaacagaattcatacgagaaggcgacgatgaccggactgtgtgccgggagatccgccacaactccacgggctgcctgcggatgaaggaccagtgtgacaagtgccgggagatcttgtctgtggactgttccaccaacaacccctcccaggctaagctgcggcgggagctcgacgaatccctccaggtcgctgagaggttgaccaggaaatacaacgagctgctaaagtcctaccagtggaagatgctcaacacctcctccttgctggagcagctgaacgagcagtttaactgggtgtcccggctggcaaacctcacgcaaggcgaagaccagtactatctgcgggtcaccacggtggcttcccacacttctgactcggacgttccttccggtgtcactgaggtggtcgtgaagctctttgactctgatcccatcactgtgacggtccctgtagaagtctccaggaagaaccctaaatttatggagaccgtggcggagaaagcgctgcaggaataccgcaaaaagcaccgggaggagtgagatgtggatgttgcttttgcacctacgggggcatctgagtccagctccccccaagatgagctgcagccccccagagagagctctgcacgtcaccaagtaaccaggccccagcctccaggcccccaactccgcccagcctctccccgctctggatcctgcactctaacactcgactctgctgctcatgggaagaacagaattgctcctgcatgcaactaattcaataaaactgtcttgtgagctgatcgcttggagggtcctctttttatgttgagttgctgcttcccggcatgccttcattttgctatggggggcaggcaggggggatggaaaataagtagaaacaaaaaagcagtggctaagatggtatagggactgtcataccagtgaagaataaaagggtgaagaataaaagggatatgatgacaaggttgatccacttcaagaattgcttgctttcaggaagagagatgtgtttcaacaagccaactaaaatatattgctgcaaatggaagcttttctgttctattataaaactgtcgatgtattctgaccaaggtgcgacaatctcctaaaggaatacactgaaagttaaggagaagaatcagtaagtgtaaggtgtacttggtattataatgcataattgatgttttcgttatgaaaacatttggtgcccagaagtccaaattatcagttttatttgtaagagctattgcttttgcagcggttttatttgtaaaagctgttgatttcgagttgtaagagctcagcatcccaggggcatcttcttgactgtggcatttcctgtccaccgccggtttatatgatcttcatacctttccctggaccacaggcgtttctcggcttttagtctgaaccatagctgggctgcagtaccctacgctgccagcaggtggccatgactacccgtggtaccaatctcagtcttaaagctcaggcttttcgttcattaacattctctgatagaattctggtcatcagatgtactgcaatggaacaaaactcatctggctgcatcccaggtgtgtagcaaagtccacatgtaaatttatagcttagaatattcttaagtcactgtcccttgtctctctttgaagttataaacaacaaacttaaagcttagcttatgtccaaggtaagtattttagcatggctgtcaaggaaattcagagtaaagtcagtgtgattcacttaatgatatacattaattagaattatggggtcagaggtatttgcttaagtgatcataattgtaaagtatatgtcacattgtcacattaatgtcaaaaaaaaaaaaaaaaaa

SEQ ID NO: 2 - protein, 501 aa, Homo sapiens
MQVCSQPQRGCVREQSAINTAPPSAHNAASPGGARGHRVPLTEACKDSRIGGMMKTLLLFVGLLLTWESGQVLGDQTVSDNELQEMSNQGSKYVNKEIQNAVNGVKQIKTLIEKTNEERKTLLSNLEEAKKKKEDALNETRESETKLKELPGVCNETMMALWEECKPCLKQTCMKFYARVCRSGSGLVGRQLEEFLNQSSPFYFWMNGDRIDSLLENDRQQTHMLDVMQDHFSRASSIIDELFQDRFFTREPQDTYHYLPFSLPHRRPHFFFPKSRIVRSLMPFSPYEPLNFHAMFQPFLEMIHEAQQAMDIHFHSPAFQHPPTEFIREGDDDRTVCREIRHNSTGCLRMKDQCDKCREILSVDCSTNNPSQAKLRRELDESLQVAERLTRKYNELLKSYQWKMLNTSSLLEQLNEQFNWVSRLANLTQGEDQYYLRVTTVASHTSDSDVPSGVTEVVVKLFDSDPITVTVPVEVSRKNPKFMETVAEKALQEYRKKHREE

SEQ ID NO: 3 - DNA, 9979 bp, Homo sapiens
ttttgtcccggaaccccgcagccctccccacactctgggcgcggagcacaatgattggtcactcctattttcgctgagcttttcctcttatttcagttttcttcgagatcaaatctggtttgtagatgtgcttggggagaatgggggcctcttctccaagaagcccggagcctgtcgggccgccggcgcccggtctccccttctgctgcggaggatccctgctggcggttgtggtgctgcttgcgctgccggtggcctggggtcaatgcaatgccccagaatggcttccatttgccaggcctaccaacctaactgatgaatttgagtttcccattgggacatatctgaactatgaatgccgccctggttattccggaagaccgttttctatcatctgcctaaaaaactcagtctggactggtgctaaggacaggtgcagacgtaaatcatgtcgtaatcctccagatcctgtgaatggcatggtgcatgtgatcaaaggcatccagttcggatcccaaattaaatattcttgtactaaaggataccgactcattggttcctcgtctgccacatgcatcatctcaggtgatactgtcatttgggataatgaaacacctatttgtgacagaattccttgtgggctaccccccaccatcaccaatggagatttcattagcaccaacagagagaattttcactatggatcagtggtgacctaccgctgcaatcctggaagcggagggagaaaggtgtttgagcttgtgggtgagccctccatatactgcaccagcaatgacgatcaagtgggcatctggagcggccccgcccctcagtgcattatacctaacaaatgcacgcctccaaatgtggaaaatggaatattggtatctgacaacagaagcttattttccttaaatgaagttgtggagtttaggtgtcagcctggctttgtcatgaaaggaccccgccgtgtgaagtgccaggccctgaacaaatgggagccggagctaccaagctgctccagggtatgtcagccacctccagatgtcctgcatgctgagcgtacccaaagggacaaggacaacttttcacctgggcaggaagtgttctacagctgtgagcccggctacgacctcagaggggctgcgtctatgcgctgcacaccccagggagactggagccctgcagcccccacatgtgaagtgaaatcctgtgatgacttcatgggccaacttcttaatggccgtgtgctatttccagtaaatctccagcttggagcaaaagtggattttgtttgtgatgaaggatttcaattaaaaggcagctctgctagttactgtgtcttggctggaatggaaagcctttggaatagcagtgttccagtgtgtgaacaaatcttttgtccaagtcctccagttattcctaatgggagacacacaggaaaacctctggaagtctttccctttgggaaaacagtaaattacacatgcgacccccacccagacagagggacgagcttcgacctcattggagagagcaccatccgctgcacaagtgaccctcaagggaatggggtttggagcagccctgcccctcgctgtggaattctgggtcactgtcaagccccagatcattttctgtttgccaagttgaaaacccaaaccaatgcatctgactttcccattgggacatctttaaagtacgaatgccgtcctgagtactacgggaggccattctctatcacatgtctagataacctggtctggtcaagtcccaaagatgtctgtaaacgtaaatcatgtaaaactcctccagatccagtgaatggcatggtgcatgtgatcacagacatccaggttggatccagaatcaactattcttgtactacagggcaccgactcattggtcactcatctgctgaatgtatcctctcgggcaatgctgcccattggagcacgaagccgccaatttgtcaacgaattccttgtgggctaccccccaccatcgccaatggagatttcattagcaccaacagagagaattttcactatggatcagtggtgacctaccgctgcaatcctggaagcggagggagaaaggtgtttgagcttgtgggtgagccctccatatactgcaccagcaatgacgatcaagtgggcatctggagcggcccggcccctcagtgcattatacctaacaaatgcacgcctccaaatgtggaaaatggaatattggtatctgacaacagaagcttattttccttaaatgaagttgtggagtttaggtgtcagcctggctttgtcatgaaaggaccccgccgtgtgaagtgccaggccctgaacaaatgggagccggagctaccaagctgctccagggtatgtcagccacctccagatgtcctgcatgctgagcgtacccaaagggacaaggacaacttttcacccgggcaggaagtgttctacagctgtgagcccggctacgacctcagaggggctgcgtctatgcgctgcacaccccagggagactggagccctgcagcccccacatgtgaagtgaaatcctgtgatgacttcatgggccaacttcttaatggccgtgtgctatttccagtaaatctccagcttggagcaaaagtggattttgtttgtgatgaaggatttcaattaaaaggcagctctgctagttactgtgtcttggctggaatggaaagcctttggaatagcagtgttccagtgtgtgaacaaatcttttgtccaagtcctccagttattcctaatgggagacacacaggaaaacctctggaagtctttccctttgggaaaacagtaaattacacatgcgacccccacccagacagagggacgagcttcgacctcattggagagagcaccatccgctgcacaagtgaccctcaagggaatggggtttggagcagccctgcccctcgctgtggaattctgggtcactgtcaagccccagatcattttctgtttgccaagttgaaaacccaaaccaatgcatctgactttcccattgggacatctttaaagtacgaatgccgtcctgagtactacgggaggccattctctatcacatgtctagataacctggtctggtcaagtcccaaagatgtctgtaaacgtaaatcatgtaaaactcctccagatccagtgaatggcatggtgcatgtgatcacagacatccaggttggatccagaatcaactattcttgtactacagggcaccgactcattggtcactcatctgctgaatgtatcctctcgggcaatgctgcccattggagcacgaagccgccaatttgtcaacgaattccttgtgggctaccccccaccatcgccaatggagatttcattagcaccaacagagagaattttcactatggatcagtggtgacctaccgctgcaatcctggaagcggagggagaaaggtgtttgagcttgtgggtgagccctccatatactgcaccagcaatgacgatcaagtgggcatctggagcggcccggcccctcagtgcattatacctaacaaatgcacgcctccaaatgtggaaaatggaatattggtatctgacaacagaagcttattttccttaaatgaagttgtggagtttaggtgtcagcctggctttgtcatgaaaggaccccgccgtgtgaagtgccaggccctgaacaaatgggagccggagctaccaagctgctccagggtatgtcagccacctccagatgtcctgcatgctgagcgtacccaaagggacaaggacaacttttcacccgggcaggaagtgttctacagctgtgagcccggctatgacctcagaggggctgcgtctatgcgctgcacaccccagggagactggagccctgcagcccccacatgtgaagtgaaatcctgtgatgacttcatgggccaacttcttaatggccgtgtgctatttccagtaaatctccagcttggagcaaaagtggattttgtttgtgatgaaggatttcaattaaaaggcagctctgctagttattgtgtcttggctggaatggaaagcctttggaatagcagtgttccagtgtgtgaacaaatcttttgtccaagtcctccagttattcctaatgggagacacacaggaaaacctctggaagtctttccctttggaaaagcagtaaattacacatgcgacccccacccagacagagggacgagcttcgacctcattggagagagcaccatccgctgcacaagtgaccctcaagggaatggggtttggagcagccctgcccctcgctgtggaattctgggtcactgtcaagccccagatcattttctgtttgccaagttgaaaacccaaaccaatgcatctgactttcccattgggacatctttaaagtacgaatgccgtcctgagtactacgggaggccattctctatcacatgtctagataacctggtctggtcaagtcccaaagatgtctgtaaacgtaaatcatgtaaaactcctccagatccagtgaatggcatggtgcatgtgatcacagacatccaggttggatccagaatcaactattcttgtactacagggcaccgactcattggtcactcatctgctgaatgtatcctctcaggcaatactgcccattggagcacgaagccgccaatttgtcaacgaattccttgtgggctacccccaaccatcgccaatggagatttcattagcaccaacagagagaattttcactatggatcagtggtgacctaccgctgcaatcttggaagcagagggagaaaggtgtttgagcttgtgggtgagccctccatatactgcaccagcaatgacgatcaagtgggcatctggagcggccccgcccctcagtgcattatacctaacaaatgcacgcctccaaatgtggaaaatggaatattggtatctgacaacagaagcttattttccttaaatgaagttgtggagtttaggtgtcagcctggctttgtcatgaaaggaccccgccgtgtgaagtgccaggccctgaacaaatgggagccagagttaccaagctgctccagggtgtgtcagccgcctccagaaatcctgcatggtgagcataccccaagccatcaggacaacttttcacctgggcaggaagtgttctacagctgtgagcctggctatgacctcagaggggctgcgtctctgcactgcacaccccagggagactggagccctgaagccccgagatgtgcagtgaaatcctgtgatgacttcttgggtcaactccctcatggccgtgtgctatttccacttaatctccagcttggggcaaaggtgtcctttgtctgtgatgaagggtttcgcttaaagggcagttccgttagtcattgtgtcttggttggaatgagaagcctttggaataacagtgttcctgtgtgtgaacatatcttttgtccaaatcctccagctatccttaatgggagacacacaggaactccctctggagatattccctatggaaaagaaatatcttacacatgtgacccccacccagacagagggatgaccttcaacctcattggggagagcaccatccgctgcacaagtgaccctcatgggaatggggtttggagcagccctgcccctcgctgtgaactttctgttcgtgctggtcactgtaaaaccccagagcagtttccatttgccagtcctacgatcccaattaatgactttgagtttccagtcgggacatctttgaattatgaatgccgtcctgggtattttgggaaaatgttctctatctcctgcctagaaaacttggtctggtcaagtgttgaagacaactgtagacgaaaatcatgtggacctccaccagaacccttcaatggaatggtgcatataaacacagatacacagtttggatcaacagttaattattcttgtaatgaagggtttcgactcattggttccccatctactacttgtctcgtctcaggcaataatgtcacatgggataagaaggcacctatttgtgagatcatatcttgtgagccacctccaaccatatccaatggagacttctacagcaacaatagaacatcttttcacaatggaacggtggtaacttaccagtgccacactggaccagatggagaacagctgtttgagcttgtgggagaacggtcaatatattgcaccagcaaagatgatcaagttggtgtttggagcagccctccccctcggtgtatttctactaataaatgcacagctccagaagttgaaaatgcaattagagtaccaggaaacaggagtttctttaccctcactgagatcatcagatttagatgtcagcccgggtttgtcatggtagggtcccacactgtgcagtgccagaccaatggcagatgggggcccaagctgccacactgctccagggtgtgtcagccgcctccagaaatcctgcatggtgagcataccctaagccatcaggacaacttttcacctgggcaggaagtgttctacagctgtgagcccagctatgacctcagaggggctgcgtctctgcactgcacgccccagggagactggagccctgaagcccctagatgtacagtgaaatcctgtgatgacttcctgggccaactccctcatggccgtgtgctacttccacttaatctccagcttggggcaaaggtgtcctttgtttgcgatgaagggttccgattaaaaggcaggtctgctagtcattgtgtcttggctggaatgaaagccctttggaatagcagtgttccagtgtgtgaacaaatcttttgtccaaatcctccagctatccttaatgggagacacacaggaactccctttggagatattccctatggaaaagaaatatcttacgcatgcgacacccacccagacagagggatgaccttcaacctcattggggagagctccatccgctgcacaagtgaccctcaagggaatggggtttggagcagccctgcccctcgctgtgaactttctgttcctgctgcctgcccacatccacccaagatccaaaacgggcattacattggaggacacgtatctctatatcttcctgggatgacaatcagctacatttgtgaccccggctacctgttagtgggaaagggcttcattttctgtacagaccagggaatctggagccaattggatcattattgcaaagaagtaaattgtagcttcccactgtttatgaatggaatctcgaaggagttagaaatgaaaaaagtatatcactatggagattatgtgactttgaagtgtgaagatgggtatactctggaaggcagtccctggagccagtgccaggcggatgacagatgggaccctcctctggccaaatgtacctctcgtacacatgatgctctcatagttggcactttatctggtacgatcttctttattttactcatcattttcctctcttggataattctaaagcacagaaaaggcaataatgcacatgaaaaccctaaagaagtggctatccatttacattctcaaggaggcagcagcgttcatccccgaactctgcaaacaaatgaagaaaatagcagggtccttccttgacaaagtactatacagctgaagaacatctcgaatacaattttggtgggaaaggagccaattgatttcaacagaatcagatctgagcttcataaagtctttgaagtgacttcacagagacgcagacatgtgcacttgaagatgctgccccttccctggtacctagcaaagctcctgcctctttgtgtgcgtcactgtgaaacccccacccttctgcctcgtgctaaacgcacacagtatctagtcaggggaaaagactgcatttaggagatagaaaatagtttggattacttaaaggaataaggtgttgcctggaatttctggtttgtaaggtggtcactgttcttttttaaaatatttgtaatatggaatgggctcagtaagaagagcttggaaaatgcagaaagttatgaaaaataagtcacttataattatgctacctactgataaccactcctaatattttgattcattttctgcctatcttctttcacatatgtgtttttttacatacgtacttttcccccttagtttgtttccttttattttatagagcagaaccctagtcttttaaacagtttagagtgaaatatatgctatatcagtttttactttctctagggagaaaaattaatttactagaaaggcatgaaatgatcatgggaagagtggttaagactactgaagagaaatatttggaaaataagatttcgatatcttctttttttttgagatggagtctggctctgtctcccaggctggagtgcagtggcgtaatctcggctcactgcaagctccgcctcccgggttgacaccattttcctgcctcagcctcctgagtagttgggattaccagtagatgggactacaggcacctgccaacacgcccggctaatttttttgtatttttagtagagacggggtttcaccatgttagccaggatggtctggatctcctgacctcgtgatccacctgcctcggcctcccaaagtgctgcgattacaggcatgagccaccgcgcctggccgctttcgatattttctaaactttaattcaaaagcactttgtgctgtgttctatataaaaaacataataaaaattgaaatgaaagaataattgttattataaaagtactagcttacttttgtatggattcagaatatactaaattaactttttaaaacacaacttttaaaaaatgtatcaaaataataaacgtgttctgatatttttaaaataagtgaccttgtgttctttaaccagtccacatctttagagaacaaaaatgtgttatgatattatgggccatgctaatgacctctagaaaacatcagaatatttctggatatttaataatagctttatatatgactaatgctcatttctatgtaattctgtttaatagttgctttaaaggtgaattttgccacatttactttgacagcagtataaggagtgagatagacatgaacctgaatttcaatttaaaatcatggaagagagggaaaaaaaaccagcttaagaaaaatcaactgataaactgcaagaaaaaaatgcaacttacatcacaaaagctaattgctttattatttagagagtacttaaaaattaaagaccaaacttctctccacccaacaaaaatgggcaaaggacatacagctaggtcaccaagaaagaagggcaaataggtggtgagtatatgtaaagatacttgataggacttttgcttagttgaatctttagcaaatctcttttatttcttgggattttgaagaagtaatttttaaaggaggactagaaactaagtgattgggaattggcctttttagaattaaaatttcccattacaagaaaaaaaaatcctgtgttcttttttttttccagaatggagtaggtcagtgagcaatgtgattaataaatatttcaatgtctgtgacttttgatttattttggagacagggtcttgctctgttacccaggctggagtgcagtggtgctatctaggcttactgcaacctcacctgtcactttttaattgcaagaaagctgaaaggtttttttctattatatcagttataatgataaatactgtatatactaactatgagtaaaatactatattgcctaacttgtattattaagcaattctgctaacctgtgaccttacattttcatctgaaaagcaggggctggacaccaattgccctatgaagctattgctagtcctaacattctttgttttgtttgcttttttggcacacttaagtgtgtactatgaagtttatgatgctttaatgaaattttctgtctctaccattgtaatgagaaaggaataaaatactttattttgcaaatctaaaaaaaaaaaaaa

SEQ ID NO: 4 - protein, 2489 aa, Homo sapiens
MGASSPRSPEPVGPPAPGLPFCCGGSLLAVVVLLALPVAWGQCNAPEWLPFARPTNLTDEFEFPIGTYLNYECRPGYSGRPFSIICLKNSVWTGAKDRCRRKSCRNPPDPVNGMVHVIKGIQFGSQIKYSCTKGYRLIGSSSATCIISGDTVIWDNETPICDRIPCGLPPTITNGDFISTNRENFHYGSVVTYRCNPGSGGRKVFELVGEPSIYCTSNDDQVGIWSGPAPQCIIPNKCTPPNVENGILVSDNRSLFSLNEVVEFRCQPGFVMKGPRRVKCQALNKWEPELPSCSRVCQPPPDVLHAERTQRDKDNFSPGQEVFYSCEPGYDLRGAASMRCTPQGDWSPAAPTCEVKSCDDFMGQLLNGRVLFPVNLQLGAKVDFVCDEGFQLKGSSASYCVLAGMESLWNSSVPVCEQIFCPSPPVIPNGRHTGKPLEVFPFGKTVNYTCDPHPDRGTSFDLIGESTIRCTSDPQGNGVWSSPAPRCGILGHCQAPDHFLFAKLKTQTNASDFPIGTSLKYECRPEYYGRPFSITCLDNLVWSSPKDVCKRKSCKTPPDPVNGMVHVITDIQVGSRINYSCTTGHRLIGHSSAECILSGNAAHWSTKPPICQRIPCGLPPTIANGDFISTNRENFHYGSVVTYRCNPGSGGRKVFELVGEPSIYCTSNDDQVGIWSGPAPQCIIPNKCTPPNVENGILVSDNRSLFSLNEVVEFRCQPGFVMKGPRRVKCQALNKWEPELPSCSRVCQPPPDVLHAERTQRDKDNFSPGQEVFYSCEPGYDLRGAASMRCTPQGDWSPAAPTCEVKSCDDFMGQLLNGRVLFPVNLQLGAKVDFVCDEGFQLKGSSASYCVLAGMESLWNSSVPVCEQIFCPSPPVIPNGRHTGKPLEVFPFGKTVNYTCDPHPDRGTSFDLIGESTIRCTSDPQGNGVWSSPAPRCGILGHCQAPDHFLFAKLKTQTNASDFPIGTSLKYECRPEYYGRPFSITCLDNLVWSSPKDVCKRKSCKTPPDPVNGMVHVITDIQVGSRINYSCTTGHRLIGHSSAECILSGNAAHWSTKPPICQRIPCGLPPTIANGDFISTNRENFHYGSVVTYRCNPGSGGRKVFELVGEPSIYCTSNDDQVGIWSGPAPQCIIPNKCTPPNVENGILVSDNRSLFSLNEVVEFRCQPGFVMKGPRRVKCQALNKWEPELPSCSRVCQPPPDVLHAERTQRDKDNFSPGQEVFYSCEPGYDLRGAASMRCTPQGDWSPAAPTCEVKSCDDFMGQLLNGRVLFPVNLQLGAKVDFVCDEGFQLKGSSASYCVLAGMESLWNSSVPVCEQIFCPSPPVIPNGRHTGKPLEVFPFGKAVNYTCDPHPDRGTSFDLIGESTIRCTSDPQGNGVWSSPAPRCGILGHCQAPDHFLFAKLKTQTNASDFPIGTSLKYECRPEYYGRPFSITCLDNLVWSSPKDVCKRKSCKTPPDPVNGMVHVITDIQVGSRINYSCTTGHRLIGHSSAECILSGNTAHWSTKPPICQRIPCGLPPTIANGDFISTNRENFHYGSVVTYRCNLGSRGRKVFELVGEPSIYCTSNDDQVGIWSGPAPQCIIPNKCTPPNVENGILVSDNRSLFSLNEVVEFRCQPGFVMKGPRRVKCQALNKWEPELPSCSRVCQPPPEILHGEHTPSHQDNFSPGQEVFYSCEPGYDLRGAASLHCTPQGDWSPEAPRCAVKSCDDFLGQLPHGRVLFPLNLQLGAKVSFVCDEGFRLKGSSVSHCVLVGMRSLWNNSVPVCEHIFCPNPPAILNGRHTGTPSGDIPYGKEISYTCDPHPDRGMTFNLIGESTIRCTSDPHGNGVWSSPAPRCELSVRAGHCKTPEQFPFASPTIPINDFEFPVGTSLNYECRPGYFGKMFSISCLENLVWSSVEDNCRRKSCGPPPEPFNGMVHINTDTQFGSTVNYSCNEGFRLIGSPSTTCLVSGNNVTWDKKAPICEIISCEPPPTISNGDFYSNNRTSFHNGTVVTYQCHTGPDGEQLFELVGERSIYCTSKDDQVGVWSSPPPRCISTNKCTAPEVENAIRVPGNRSFFTLTEIIRFRCQPGFVMVGSHTVQCQTNGRWGPKLPHCSRVCQPPPEILHGEHTLSHQDNFSPGQEVFYSCEPSYDLRGAASLHCTPQGDWSPEAPRCTVKSCDDFLGQLPHGRVLLPLNLQLGAKVSFVCDEGFRLKGRSASHCVLAGMKALWNSSVPVCEQIFCPNPPAILNGRHTGTPFGDIPYGKEISYACDTHPDRGMTFNLIGESSIRCTSDPQGNGVWSSPAPRCELSVPAACPHPPKIQNGHYIGGHVSLYLPGMTISYICDPGYLLVGKGFIFCTDQGIWSQLDHYCKEVNCSFPLFMNGISKELEMKKVYHYGDYVTLKCEDGYTLEGSPWSQCQADDRWDPPLAKCTSRTHDALIVGTLSGTIFFILLIIFLSWIILKHRKGNNAHENPKEVAIHLHSQGGSSVHPRTLQTNEENSRVLP

SEQ ID NO: 5 - DNA, 52 bp, Homo sapiens
  misc_feature (26)..(26): c or t
cttctgataaggaagtcctcctgctnctccaaggaaacctagagagctgacc

SEQ ID NO: 6 - DNA, 52 bp, Homo sapiens
  misc_feature (27)..(27): c or t
caccaaagccacaccagctatcaaaantctctaacgggcccttgccacttga

SEQ ID NO: 7 - DNA, 52 bp, Homo sapiens
  misc_feature (27)..(27): c or g
agagcaagaggactcatccttccaaanggactttctctgggaagcctgctcc

SEQ ID NO: 8 - DNA, 52 bp, Homo sapiens
  misc_feature (27)..(27): a or g
atttccttctctgtctccatcttctcntcgccttctcctctgtgtgtgtcct

SEQ ID NO: 9 - DNA, 52 bp, Homo sapiens
  misc_feature (26)..(26): a or g
agccctctggtaagcataagatatancaaaggaaattgccccatatctaaca

SEQ ID NO: 10 - DNA, 52 bp, Homo sapiens
  misc_feature (27)..(27): c or t
tcaccgtggtctcgatatcctgacctngtgatccactcgcctcggcctccca

SEQ ID NO: 11 - DNA, 52 bp, Homo sapiens
  misc_feature (26)..(26): t or a
tccagcctgggcaacagagtgcgacnctgtctctaaaaagaaaaaaataatt

SEQ ID NO: 12 - DNA, 52 bp, Homo sapiens
  misc_feature (26)..(26): g or a
ttggctcatgcctgtaatcacagcantctgggaggctgaggcaagaggatca

SEQ ID NO: 13 - DNA, 52 bp, Homo sapiens
  misc_feature (27)..(27): c or t
agctgatgcctatatattgcttgccangtgcctgaccattttaaacaccttc

SEQ ID NO: 14 - DNA, 52 bp, Homo sapiens
  misc_feature (27)..(27): a or g
cagtagctgatgcctatatattgcttnccacgtgcctgaccattttaaacac

SEQ ID NO: 15 - DNA, 52 bp, Homo sapiens
  misc_feature (27)..(27): c or t
ccacaccccagagttaggtgaggtctntgtcctgctccatcatcccctgtcc

SEQ ID NO: 16 - DNA, 52 bp, Homo sapiens
  misc_feature (27)..(27): c or t
ctgtctgggcccctgccgccaccccanccagagcctgcttggaactagcatg

SEQ ID NO: 17 - DNA, 52 bp, Homo sapiens
  misc_feature (27)..(27): c or t
catccagagcctgcttggaactagcangtgatcagggcttagaaacatctat

SEQ ID NO: 18 - DNA, 52 bp, Homo sapiens
  misc_feature (27)..(27): c or t
gcaaatgaaccttccctgcttcttaantgcagcctcagcatcagctgacaca

SEQ ID NO: 19 - DNA, 52 bp, Homo sapiens
  misc_feature (27)..(27): a or g
gtctcctctggtggaggaaagctctantaggaccctgcagtgccaggtccgc

SEQ ID NO: 20 - DNA, 52 bp, Homo sapiens
  misc_feature (27)..(27): a or g
agaactactggatacttcctgggtttnccactatcctattttctagtggggc

SEQ ID NO: 21 - DNA, 52 bp, Homo sapiens
  misc_feature (27)..(27): c or t
attctggacctcatctctcttgaaacncttggcccagccctggactagccaa

SEQ ID NO: 22 - DNA, 52 bp, Homo sapiens
  misc_feature (26)..(26): g or c
cacgcagagcctgaaccaggggcctnggagctgaggctcagagtgggcccag

SEQ ID NO: 23 - DNA, 52 bp, Homo sapiens
  misc_feature (26)..(26): t or c
ctgctccccctttgccacaagagtcntagaagccagacactaagggctcagg

SEQ ID NO: 24 - DNA, 52 bp, Homo sapiens
  misc_feature (27)..(27): c or t
tacaggcatgagccaccactcccagcngtaactacatagcttaaaaacaata

SEQ ID NO: 25 - DNA, 52 bp, Homo sapiens
  misc_feature (27)..(27): c or g
acagagtgagactctgtctcggggggnggggggggggggaagcagcaaccaa

SEQ ID NO: 26 - DNA, 52 bp, Homo sapiens
  misc_feature (27)..(27): c or g
ggccaggctggtcttgaactcctgacntcaagtaatctgcccgcctcggcct

SEQ ID NO: 27 - DNA, 52 bp, Homo sapiens
  misc_feature (27)..(27): a or g
aggaatcccctgacaaagaaaaagatncttaaaaatatttgaaacagtatta

SEQ ID NO: 28 - DNA, 52 bp, Homo sapiens
  misc_feature (27)..(27): c or t
ttcctctggttcccacacagcgagaangtcagtgccatccaccaggaccaca

SEQ ID NO: 29 - DNA, 52 bp, Homo sapiens
  misc_feature (27)..(27): c or g
tggccaggctggtccccaagacaccanagagcatctgcctagaaagaggcaa

SEQ ID NO: 30 - DNA, 52 bp, Homo sapiens
  misc_feature (27)..(27): a or c
gcgcttggcgcttgggaacagaatcancggggagtcccagggggatgacttt

SEQ ID NO: 31 - DNA, 52 bp, Homo sapiens
  misc_feature (27)..(27): a or g
caaaaattagctgggcatggtggcacncgcctgcagtcccagctactcggga

SEQ ID NO: 32 - DNA, 52 bp, Homo sapiens
  misc_feature (27)..(27): c or t
ttttggttttgttttgttttttaatanggagctcatcccgtcgcccagcctg

SEQ ID NO: 33 - DNA, 52 bp, Homo sapiens
  misc_feature (26)..(26): g or c
actgggcaagtgccccaagaggtggnctttcaatgtcggagagccaaaaaac

SEQ ID NO: 34 - DNA, 52 bp, Homo sapiens
  misc_feature (27)..(27): g or t
aaagtgaccctttgtgtgttgtcagtntttttccaaccagattatcattttt

SEQ ID NO: 35 - DNA, 52 bp, Homo sapiens
  misc_feature (27)..(27): g or t
aaggttcataggtattaacttgacccnattaagccctctttgaagatttatc

SEQ ID NO: 36 - DNA, 52 bp, Homo sapiens
  misc_feature (27)..(27): g or t
cagctactcaggaagctgagatggagnatcgcttgagcccaggaggtcaagg

SEQ ID NO: 37 - DNA, 52 bp, Homo sapiens
  misc_feature (27)..(27): c or t
tgaagacagagatgtttccagtcctanttgcagtaacctaaaattgcaggac

SEQ ID NO: 38 - DNA, 52 bp, Homo sapiens
  misc_feature (27)..(27): c or g
aaatattattttatttatttatttttnagacagggtctcactctgtcaccca

SEQ ID NO: 39 - DNA, 52 bp, Homo sapiens
  misc_feature (27)..(27): a or g
gttttcaactatttatttttaaataanatttcccctctgtcacttgtctatc

SEQ ID NO: 40 - DNA, 52 bp, Homo sapiens
  misc_feature (27)..(27): a or g
ctgcatagtattccatggtgtataccntagtattccatggtgtatatatacc

SEQ ID NO: 41 - DNA, 52 bp, Homo sapiens
  misc_feature (27)..(27): a or g
ttctgagtgattttctccggacctccntaaagtccagaaacattcactccat

SEQ ID NO: 42 - DNA, 52 bp, Homo sapiens
  misc_feature (27)..(27): a or t
tgtatttcactccagagttgctttacngtgacctttagctccaattattagg

SEQ ID NO: 43 - DNA, 52 bp, Homo sapiens
  misc_feature (27)..(27): a or g
ggaagagatcaatttccctgagcactnagggctgatactatgttctcaggag

SEQ ID NO: 44 - DNA, 52 bp, Homo sapiens
  misc_feature (27)..(27): c or t
ctttataacagcattatttacaatagncaaatgtcttatcaagacaaatgga

SEQ ID NO: 45 - DNA, 52 bp, Homo sapiens
  misc_feature (27)..(27): c or t
caggggagggggactacaggtggcacnagagggaccccactaaacaaaccat

SEQ ID NO: 46 - DNA, 52 bp, Homo sapiens
  misc_feature (26)..(26): g or a
ttggcgggtgctggaaggccgggctntggaagtggatgtccatggcctgctg

SEQ ID NO: 47 - DNA, 52 bp, Homo sapiens
  misc_feature (27)..(27): a or c
cgatcatgtcagacactgaaaataccncccttaggtcatgcatccgtccctc

SEQ ID NO: 48 - DNA, 52 bp, Homo sapiens
  misc_feature (27)..(27): a or g
tttcatattctaagcagatcatagacnttgattggttcaggactcacacact

SEQ ID NO: 49 - DNA, 52 bp, Homo sapiens
  misc_feature (26)..(26): t or c
agctccggtggtccagacacagcttngtggaggaggcctgggagctgggcta

SEQ ID NO: 50 - DNA, 52 bp, Homo sapiens
  misc_feature (26)..(26): t or c
gtggacacagggctctgccatcccangaagcagtttattatgtcatccagct

SEQ ID NO: 51 - DNA, 52 bp, Homo sapiens
  misc_feature (27)..(27): c or t
gtggcagaaagaaagatcatgatcctngttagacttaaaggtcagggatgta

SEQ ID NO: 52 - DNA, 52 bp, Homo sapiens
  misc_feature (27)..(27): g or t
tcctcgttagacttaaaggtcagggangtaaacctcccaaacatctatgtaa

SEQ ID NO: 53 - DNA, 52 bp, Homo sapiens
  misc_feature (27)..(27): c or t
gttactacaactgaaggacggaagggnttccagcctctagtaggtagaggcc

SEQ ID NO: 54 - DNA, 52 bp, Homo sapiens
  misc_feature (27)..(27): a or t
agtgagccaagactgtgccattgcacnccagcctgggtgacagagtgagact

SEQ ID NO: 55 - DNA, 52 bp, Homo sapiens
  misc_feature (27)..(27): c or g
ctaattttctgtatctatatcagtctntagttaaaaccacacaggggaaatg

SEQ ID NO: 56 - DNA, 52 bp, Homo sapiens
  misc_feature (27)..(27): a or c
gaaggaagccatgtgggaaacacagantatgagtggagagtatcgtagtggt

SEQ ID NO: 57 - DNA, 52 bp, Homo sapiens
  misc_feature (27)..(27): a or g
atttgggtatctcttcctaaattcatntcaaactagaagcatcaattgcttt

SEQ ID NO: 58 - DNA, 52 bp, Homo sapiens
  misc_feature (27)..(27): a or g
caggaccagttgagtcatgagtcacangtccaggtagagtcagtcagttgcc

SEQ ID NO: 59 - DNA, 52 bp, Homo sapiens
  misc_feature (27)..(27): -, c or t
tgttttcttttccatgctaaattaacntctgatgaatagagacaatttttta

SEQ ID NO: 60 - DNA, 52 bp, Homo sapiens
  misc_feature (27)..(27): c or t
taactcttcaagcttccattctaaaanccctaataccaactcatacataaaa

SEQ ID NO: 61 - DNA, 52 bp, Homo sapiens
  misc_feature (27)..(27): a or t
gaaaaacataaataaataaattaaatnaaataaaacaagaaaagaaactaaa

SEQ ID NO: 62 - DNA, 52 bp, Homo sapiens
  misc_feature (27)..(27): a or g
atccctgcactttgggaggctgaggcnggtgggtcacctgaggtcaggagtt

SEQ ID NO: 63 - DNA, 52 bp, Homo sapiens
  misc_feature (27)..(27): a or g
accagctactcgggaggttgaagcatnagaattgcttgaacccaggaggcag

SEQ ID NO: 64 - DNA, 52 bp, Homo sapiens
  misc_feature (27)..(27): a or g
aaattatgtcagaaatagtgaaatgtnttaaggcatggacatctgcctataa

SEQ ID NO: 65 - DNA, 52 bp, Homo sapiens
  misc_feature (27)..(27): a or c
aacatggtactcctgttccctcacagngtgaccccagtggctccagggctag

SEQ ID NO: 66 - DNA, 52 bp, Homo sapiens
  misc_feature (27)..(27): g or t
tactttcttttttttttttgatacaangtcttgctttgttgcccaggctgga

SEQ ID NO: 67 - DNA, 52 bp, Homo sapiens
  misc_feature (27)..(27): a or g
ccaagaggaaggttctttaaagagctntgctcaggatggtctttctgttgta

SEQ ID NO: 68 - DNA, 52 bp, Homo sapiens
  misc_feature (27)..(27): a or c
cctgtgaaatggagataataatagttnctaccttacttaacatagtgcctca

SEQ ID NO: 69 - DNA, 52 bp, Homo sapiens
  misc_feature (26)..(26): c or a
tattggattattattgtcatttccantgttttggggtgatgactctataagt

SEQ ID NO: 70 - DNA, 52 bp, Homo sapiens
  misc_feature (26)..(26): t or c
tgacatgaccccacccccacattccnagtctctcttatcctgctttattttt

SEQ ID NO: 71 - DNA, 52 bp, Homo sapiens
  misc_feature (27)..(27): c or t
actatgagaaatttctcactggctagntccccttttaacctgggctttccat

SEQ ID NO: 72 - DNA, 52 bp, Homo sapiens
  misc_feature (27)..(27): a or g
tgatacttcttaccttcttgattgtcnttaccttatacgtgatatcaaaaca

SEQ ID NO: 73 - DNA, 52 bp, Homo sapiens
  misc_feature (27)..(27): a or g
agctcaagaccagcctagacaacatgncaaaaacccatctctacaaaaaagt

SEQ ID NO: 74 - DNA, 52 bp, Homo sapiens
  misc_feature (26)..(26): c or a
caaaggcaaaactccatctgaaaaanataaataaataaattaaataaaataa

SEQ ID NO: 75 - DNA, 52 bp, Homo sapiens
  misc_feature (26)..(26): g or  a
accaaatgggaagagaggttctcaanccagtccatggatttacctggaactt

SEQ ID NO: 76 - DNA, 52 bp, Homo sapiens
  misc_feature (26)..(26): g or a
gtggagaagagttttattgagtgacnaaacagcttctcagcggagacgagac

SEQ ID NO: 77 - DNA, 52 bp, Homo sapiens
  misc_feature (27)..(27): c or t
aattttaagacagtgacagtaggattngtggatagtttgtatcagaatatga

SEQ ID NO: 78 - DNA, 52 bp, Homo sapiens
  misc_feature (27)..(27): a or t
aaaatttgggctttgtcatcatgtggntgtacataacaaggagactgaataa

SEQ ID NO: 79 - DNA, 52 bp, Homo sapiens
  misc_feature (27)..(27): a or g
aacaaggagactgaataagatctccgngaagtgaaagaggctagcaaaaaga

SEQ ID NO: 80 - DNA, 52 bp, Homo sapiens
  misc_feature (27)..(27): c or t
attacctgaataacaatggtacaaatngggattaccttcctaggaaatatgt

SEQ ID NO: 81 - DNA, 54 bp, Homo sapiens
  misc_feature (26)..(26): t, g or a
tgtgacttttgtcttccttttaggtncacatgatgctctctcatagttggtaag

SEQ ID NO: 82 - DNA, 52 bp, Homo sapiens
  misc_feature (27)..(27): c or t
agagcagtttccatttgccagtcctangatcccaattaatgactttgagttt

SEQ ID NO: 83 - DNA, 52 bp, Homo sapiens
  misc_feature (27)..(27): a or g
ggcgctaagactcaatttcacactacncgcccaggccacgcccacctgtcat

SEQ ID NO: 84 - DNA, 52 bp, Homo sapiens
  misc_feature (27)..(27): c or t
ctcgcccctcaatctgcattgatccantccttaatttacatgtaaccgaaat

SEQ ID NO: 85 - DNA, 52 bp, Homo sapiens
  misc_feature (27)..(27): a or g
aattggggctgggccttagattgtganctaagtgtcctcttggctgaaacag

SEQ ID NO: 86 - DNA, 52 bp, Homo sapiens
  misc_feature (27)..(27): c or t
tttatgtggaaaaagaatcagatgaanggcatatatggcaagatctcacttt

SEQ ID NO: 87 - DNA, 52 bp, Homo sapiens
  misc_feature (27)..(27): -, c or t
cagtgtccacatgtataaaatgagcanaactgacatcctgatctctgagaga

SEQ ID NO: 88 - DNA, 52 bp, Homo sapiens
  misc_feature (27)..(27): -, c or t
gcggtttgcctaagacctcatagccantaagtagaagacattgggttcaaga

SEQ ID NO: 89 - DNA, 52 bp, Homo sapiens
  misc_feature (27)..(27): c or t
cctcaaggttcattaatgttgtagcangtgtcagaatttctttcctttttaa

SEQ ID NO: 90 - DNA, 52 bp, Homo sapiens
  misc_feature (27)..(27): a or c
aaatgttacttttactagaaagtttangagcttcagaatctaagtttacaaa

SEQ ID NO: 91 - DNA, 52 bp, Homo sapiens
  misc_feature (27)..(27): c or t
tggcaaaggtggaatgcaagctcatgnctgagtttaaactgctttctcctac

SEQ ID NO: 92 - DNA, 52 bp, Homo sapiens
  misc_feature (27)..(27): c or t
agaaaccatagtcttccagaatcacantgaactatgggaaagaggggatttc

SEQ ID NO: 93 - DNA, 52 bp, Homo sapiens
  misc_feature (27)..(27): c or g
atgctgggaagtcctgtgaaatggaangagaacgaagatgaggaatctggtg

SEQ ID NO: 94 - DNA, 52 bp, Homo sapiens
  misc_feature (27)..(27): -, a, c or t
atgctgatggatgcttccagtgtgcanggtcctttggaattttaaagaagta

SEQ ID NO: 95 - DNA, 52 bp, Homo sapiens
  misc_feature (27)..(27): a, c or g
gccaggcctaccaacctaactgatgantttgagtttcccattgggacatatc

SEQ ID NO: 96 - DNA, 52 bp, Homo sapiens
  misc_feature (27)..(27): a or c
cccatttctacacaaaacagccttgtncacagtcaaaatttcaaagtttcca

SEQ ID NO: 97 - DNA, 52 bp, Homo sapiens
  misc_feature (27)..(27): a or c
cttatacgtgatatcaaaacacagagnacggtaagttcaaaggcgaatactt

SEQ ID NO: 98 - DNA, 52 bp, Homo sapiens
  misc_feature (27)..(27): c or t
ccaccgtgcccggcctctatgttttanagagaatatgtgccttagacacatc

SEQ ID NO: 99 - DNA, 52 bp, Homo sapiens
  misc_feature (27)..(27): a, c or g
taatgtctccattttcgccatactttntatgtcctacatagcagccatcaca

SEQ ID NO: 100 - DNA, 52 bp, Homo sapiens
  misc_feature (27)..(27): a or g
ttctatgctcacagtgtaaacaaagcnccagggaagcctgaactgggtggag

SEQ ID NO: 101 - DNA, 52 bp, Homo sapiens
  misc_feature (27)..(27): c or t
tttggtgaggatgcaaagcaaatggtnaatatttgggagttttaatcaggaa

SEQ ID NO: 102 - DNA, 52 bp, Homo sapiens
  misc_feature (27)..(27): -, a or g
agtattcttaagcttctttgcatattnttagacatttgcatatacaccttga

SEQ ID NO: 103 - DNA, 52 bp, Homo sapiens
  misc_feature (27)..(27): a or g
tgataatgcctgcagcccaacagatgncagtgtgcttaacagctctgtcaat

SEQ ID NO: 104 - DNA, 52 bp, Homo sapiens
  misc_feature (27)..(27): c or t
gctgagatcacgccactgcactccagngtggggaacagagtgaggatctgtt

SEQ ID NO: 105 - DNA, 52 bp, Homo sapiens
  misc_feature (27)..(27): c or t
caccagaatcacttgaacctgggaggnggagtttgcagtgagccgagatggc

SEQ ID NO: 106 - DNA, 52 bp, Homo sapiens
  misc_feature (27)..(27): a or g
aggaatgggctctgagcagtgctggcngctggaccaggcatgtcgcactgaa

SEQ ID NO: 107 - DNA, 52 bp, Homo sapiens
  misc_feature (27)..(27): c or g
cagtgaatagaaagcaaattattcagntgagagtgaggctcagaaaggaggt

SEQ ID NO: 108 - DNA, 52 bp, Homo sapiens
  misc_feature (27)..(27): c or g
aaggtttaaagtcaaaattattttaanagaaaaacccaggcaaaatagccta

SEQ ID NO: 109 - DNA, 52 bp, Homo sapiens
  misc_feature (27)..(27): a or g
acccaggcaaaatagcctacctacagncaggcagtacatgtcagaaggacag

SEQ ID NO: 110 - DNA, 52 bp, Homo sapiens
  misc_feature (27)..(27): -, a or g
gataacaatacatacccactagaatgnctaaaatgaaaaagattgaccgagc

SEQ ID NO: 111 - DNA, 52 bp, Homo sapiens
  misc_feature (27)..(27): a or c
aacaggggtgcccatgaccccaaagcncagaggaggtgttacagcacactaa

SEQ ID NO: 112 - DNA, 52 bp, Homo sapiens
  misc_feature (27)..(27): a or g
atggaggaaggcaaaggggaagcaagncatctcatacggtgggagcaggagg

SEQ ID NO: 113 - DNA, 52 bp, Homo sapiens
  misc_feature (27)..(27): c or g
agccacattcagtttcacaggtatganagcaaaataatggagaattgattct

SEQ ID NO: 114 - DNA, 52 bp, Homo sapiens
  misc_feature (27)..(27): g or t
aataatggagaattgattctaaccagnaatgttgttttgtctaatggctata

SEQ ID NO: 115 - DNA, 52 bp, Homo sapiens
  misc_feature (27)..(27): a or g
tctccacatgccagtgatttctgttcntttttctttatctccagtgaaatcc

SEQ ID NO: 116 - DNA, 52 bp, Homo sapiens
  misc_feature (27)..(27): c or t
gaagcattttctggggttatgatggcnttacctttattaggaagtatggttt

SEQ ID NO: 117 - DNA, 52 bp, Homo sapiens
  misc_feature (27)..(27): a or t
cagtgggtgcaagatggtgattataangacagagtatggaatttaacctggt

SEQ ID NO: 118 - DNA, 52 bp, Homo sapiens
  misc_feature (27)..(27): c or t
cacaacgtgcaggtttgttacatatgnatacatgtgcgacgttggtgtgctg

SEQ ID NO: 119 - DNA, 52 bp, Homo sapiens
  misc_feature (27)..(27): -, c or t
atgtattctcttccagttctggaggcngacgtctaaaatagatccatagggc

(19) United States
(12) Patent Application Publication
(10) Pub. No.: US 2012/0238461 A1
(43) Pub. Date: Sep. 20, 2012

(54) METHOD FOR DETERMINING THE RISK OF OCCURRENCE OF ALZHEIMER'S DISEASE

(75) Inventors: Philippe Amouyel, Marcq en Baroeul (FR); Mark Lathrop, Paris (FR); Jean-Charles Lambert, Tourcoing (FR)

(73) Assignees: INSTITUT PASTEUR DE LILLE, Lille Cedex (FR); COMMISSARIAT A L'ENERGIE ATOMIQUE ET AUX ENERGIES ALTERNATIVES, Paris (FR); INSTITUT NATIONAL DE LA SANTE ET DE LA RECHERCHE MEDICALE (INSERM), Paris (FR); UNIVERSITE LILLE 2 DROIT ET SANTE, Lille (FR)

(21) Appl. No.: 13/392,431

(22) PCT Filed: Aug. 27, 2010
(86) PCT No.: PCT/IB10/02450

§ 371 Date: Jun. 8, 2012

(30) Foreign Application Priority Data
Aug. 27, 2009 (IB) PCT/IB2009/054060

(51) Int. Cl. C40B 30/04

(52) U.S. Cl. 506/9

(57) ABSTRACT

The present invention relates to an in vitro method for determining that an individual is at risk of developing Alzheimer's disease, which comprises: —determining whether the individual harbours at least one variant allele of a susceptibility gene selected from the apolipoprotein J gene (APOJ) and the complement component receptor 1 gene (CR 1); —deducing that if the individual harbours at least one variant allele of the APOJ and/or CR1 gene, then the individual is at risk of developing Alzheimer's disease.

### FIELD OF THE INVENTION

The present invention relates to a method for determining the risk of occurrence of Alzheimer's disease.

### Technical Background

AD is a neurological disorder primarily affecting the elderly that manifests by memory disorders, cognitive decline and loss of autonomy. The incidence of AD is rising rapidly, raising fears that a large fraction of an increasingly elderly population will ultimately be affected. The need for effective preventive and therapeutic measures has motivated extensive research into the disease pathogenesis.

The pathology of AD is characterized by neuronal loss leading to atrophy and to diminution of the cerebral metabolism that initially has limited dispersion but which subsequently spreads to the entire brain. Two principal types of neuropathologic lesions are observed: (i) neurofibrillary degeneration resulting from the intraneuronal accumulation of hyperphosphorylated Tau proteins; (ii) amyloid deposits resulting from the extracellular accumulation of amyloid plaques, principally composed of amyloid β (Aβ) peptide. Currently, the processes leading to formation of these lesions and their dual association with AD are not adequately understood.

Genetic studies have provided significant insights into the molecular basis of AD. Rare hereditary early-onset forms of the disease have been linked to mutations in three different genes: the amyloid precursor protein (APP) gene on chromosome 21, the presenilin 1 (PS1) gene on chromosome 14 and the presenilin 2 (PS2) gene on chromosome 1. In vitro and in vivo studies have shown that pathogenic mutations in APP, PS1 and PS2 favour Aβ peptide production, particularly Aβn-42(43). These latter observations support the amyloid cascade hypothesis, namely of overproduction of the Aβ peptides, which would provoke neurofibrillary degeneration and finally neuronal death. These mutations, however, explain less than 1% of all AD cases whereas the vast majority of AD cases (especially late-onset forms) have other more complex genetic determinants.

Genetic studies have led to the identification of the ε4 allele of the apolipoprotein E gene (APOE) as one of the susceptibility loci for late-onset AD (Farrer et al. (1997) JAMA 278:1349-1356). Biological investigations have shown that APOE is likely to play a significant role in the fibrillogenesis and in clearance of Aβ peptide. Twin studies suggest that genes may contribute in more than 60% of AD susceptibility whereas APOE may account as much as 50% of this genetic susceptibility (Ashford & Mortimer (2002) J. Alzheimer Dis. 4:169-177).

More than 550 other genes have been proposed as candidates for involvement in the disease, but thus far none of these has been confirmed to have a role in pathogenesis (Bertram et al. (2007) Nat. Genet. 39:17-23).

Accordingly, it is an object of the present invention to provide alternative genetic risk factors to APOE for Alzheimer's disease.

### DESCRIPTION OF THE INVENTION

The present invention arises from the unexpected finding, by the present inventors, that variants of the apolipoprotein J gene (APOJ) and of the complement component receptor 1 gene (CR1) were risk factors for the onset of Alzheimer's disease.

The present invention thus relates to an in vitro method for determining that an individual is at risk of developing Alzheimer's disease, which comprises:

determining whether the individual harbours at least one variant allele of a susceptibility gene selected from the apolipoprotein J gene (APOJ) and the complement component receptor 1 gene (CR1);

deducing that if the individual harbours at least one variant allele of the APOJ and/or CR1 gene then the individual is at risk of developing Alzheimer's disease.

In an embodiment, the invention further comprises further determining whether the individual presents at least one other risk factor for Alzheimer's disease and deducing that the individual is at risk of developing Alzheimer's disease if said individual harbours at least one variant allele of the APOJ and/or the CR1 gene and presents said at least one other risk factor.

As intended herein the above-defined individual is preferably a human.

“Alzheimer's disease” is well known to one of skill in the art and is notably characterized by an abnormal accumulation of plaques resulting from the aggregation of the β-amyloid peptide.

As intended herein, the expression “the individual is at risk of developing Azheimer's disease” notably means that the individual is predisposed to develop the Alzheimer's disease or that the individual presents an increased risk of developing Alzheimer's disease with respect to a general population of individuals or to a population of individuals which do not harbour the above-defined at least one variant allele of the APOJ and/or CR1 gene.

The “apolipoprotein J gene (APOJ)”, is also known, inter alia, as the clusterin (CLU) gene. APOJ sensu stricto is localized on chromosome 8 in the cytogenetic band 8p21-p12 and in particular spans bases starting from position 27,455,514 bp from pter to position 27,466,601 bp from pter on the plus strand of chromosome 8 as defined by the build 37 of the human genome released on February 2009. The man skilled in the art can readily define other positions for the APOJ gene depending on the chosen count origin such as the centromere of the chromosome for instance. By way of example, the APOJ coding sequence (mRNA) is represented by the NCBI Reference Sequence NM_{—}001831 (SEQ ID NO: 1) and the apolipoprotein J is represented by the NCBI Reference Sequence NP_{—}001822 (SEQ ID NO: 2).

The “complement component receptor 1 gene (CR1)”, or complement component (3b/4b) receptor 1 gene, sensu stricto is localized on chromosome 1 in the cytogenetic band 1q32 and in particular spans bases starting from position 207,669,473 bp from pter to position 207,815,109 bp from pter on the plus strand of chromosome 1 as defined by the build 37 of the human genome released on February 2009. The man skilled in the art can readily define other positions for the CR1 gene depending on the chosen count origin such as the centromere of the chromosome for instance. By way of example, the CR1 coding sequence (mRNA) is represented by the NCBI Reference Sequence NM_{—}000651 (SEQ ID NO: 3) and the CR1 protein is represented by the NCBI Reference Sequence NP_{—}000642 (SEQ ID NO: 4).

As will be clear to one of skill in the art, the expression “determining whether the individual harbours at least one variant allele of a susceptibility gene selected from the apolipoprotein J gene (APOJ) and the complement component receptor 1 gene (CR1)” preferably refers to determining the presence or absence of at least one variation, such as a substitution (in particular a single nucleotide polymorphism (SNP)), a deletion (del) or an insertion (ins), at a site of polymorphism, i.e. a site of the genome which sequence is not identical in all individuals, comprised in said susceptibility gene. It is then deduced that the individual is at risk of developing Alzheimer's disease if the variation is present in the individual.

As intended herein the “susceptibility gene selected from the apolipoprotein J gene (APOJ) and the complement component receptor 1 gene (CR1)” also encompasses sequences directly upstream and downstream of the APOJ and CR1 gene sensu stricto, and in particular spans bases starting from position 27,400,000 bp from pter to position 27,520,000 bp from pter on the plus strand of chromosome 8 as defined by the build 37 of the human genome released on February 2009 for APOJ and bases starting from position 207,615,000 bp from pter to position 207,870,000 bp from pter on the plus strand of chromosome 1 as defined by the build 37 of the human genome released on February 2009 for CR1.

Where the susceptibility gene is APOJ, the invention preferably comprises:

determining the presence or absence of at least one variation selected from the group consisting of:

a C for the C/T single nucleotide polymorphism (SNP) rs2279590;

a C for the C/T SNP rs11136000; and

a G for the C/G SNP rs9331888; in the individual;

deducing that the individual is at risk of developing Alzheimer's disease if said at least one variation is present.

Still preferably, when the susceptibility gene is APOJ, the invention comprises:

determining the presence or absence of at least one variation selected from the group consisting of:

a T for the C/T SNP rs10091215;

an A for the T/A SNP rs1073742;

an A for the G/A SNP rs1073743;

a T for the C/T SNP rs10780145;

an A for the A/G SNP rs10866859;

a T for the C/T SNP rs11136000;

a T for the C/T SNP rs11787077;

a T for the C/T SNP rs1532276;

a T for the C/T SNP rs1532277;

a T for the C/T SNP rs1532278;

a G for the A/G SNP rs17057419;

an A for the A/G SNP rs17466684;

a T for the C/T SNP rs1982229;

a C for the G/C SNP rs2070926;

a T for the T/C SNP rs2279590;

a T for the T/C SNP rs2279591;

a C for the C/T SNP rs2582367;

a G for the C/G SNP rs28558661;

a C for the C/G SNP rs35810222;

an A for the A/G SNP rs4236673;

a C for the C/T SNP rs4352801;

a G for the C/G SNP rs4732728;

an A for the A/C SNP rs4732729;

an A for the A/G SNP rs4732732;

a C for the C/T SNP rs484377;

a C for the G/C SNP rs485902;

a T for the G/T SNP rs492638;

a G for the G/T SNP rs495150;

a T for the G/T SNP rs504038;

a C for the C/T SNP rs507341;

a G for the C/G SNP rs518317;

an A for the A/G SNP rs520186;

a G for the A/G SNP rs536332;

a G for the A/G SNP rs538181;

a T for the A/T SNP rs569205;

an A for the A/G SNP rs576748;

a T for the C/T SNP rs6983452;

a C for the C/T SNP rs7828131;

an A for the G/A SNP rs7982;

a C for the A/C SNP rs867230;

a G for the A/G SNP rs9314349;

a C for the T/C SNP rs9331896;

a T for the T/C SNP rs9331908;

an A for the SNP located at nucleotide position 27496798 of human chromosome 8;

a T for the SNP located at nucleotide position 27498182 of human chromosome 8;

a T for the SNP located at nucleotide position 27533395 of human chromosome 8;

a G for the SNP located at nucleotide position 27542063 of human chromosome 8;

a G for the SNP located at nucleotide position 27542086 of human chromosome 8;

an A for the SNP located at nucleotide position 27542087 of human chromosome 8; and

a T for the SNP located at nucleotide position 27542353 of human chromosome 8, in the individual;

deducing that the individual is at risk of developing Alzheimer's disease if said at least one variation is present.

Still preferably, when the susceptibility gene is APOJ, the invention comprises:

determining the presence or absence of at least one variation selected from the group consisting of:

a T for the C/T SNP rs10091215;

an A for the T/A SNP rs1073742;

an A for the G/A SNP rs1073743;

a T for the C/T SNP rs10780145;

an A for the A/G SNP rs10866859;

a T for the C/T SNP rs11136000;

a T for the C/T SNP rs11787077;

a T for the C/T SNP rs1532276;

a T for the C/T SNP rs1532277;

a T for the C/T SNP rs1532278;

a G for the A/G SNP rs17057419;

an A for the A/G SNP rs17466684;

a T for the C/T SNP rs1982229;

a C for the G/C SNP rs2070926;

a T for the T/C SNP rs2279590;

a T for the T/C SNP rs2279591;

a C for the C/T SNP rs2582367;

a G for the C/G SNP rs28558661;

a C for the C/G SNP rs35810222;

an A for the A/G SNP rs4236673;

a C for the C/T SNP rs4352801;

a G for the C/G SNP rs4732728;

an A for the A/C SNP rs4732729;

an A for the A/G SNP rs4732732;

a C for the C/T SNP rs484377;

a C for the G/C SNP rs485902;

a T for the G/T SNP rs492638;

a G for the G/T SNP rs495150;

a T for the G/T SNP rs504038;

a C for the C/T SNP rs507341;

a G for the C/G SNP rs518317;

an A for the A/G SNP rs520186;

a G for the A/G SNP rs536332;

a G for the A/G SNP rs538181;

a T for the A/T SNP rs569205;

an A for the A/G SNP rs576748;

a T for the C/T SNP rs6983452;

a C for the C/T SNP rs7828131;

an A for the G/A SNP rs7982;

a C for the A/C SNP rs867230;

a G for the A/G SNP rs9314349;

a C for the T/C SNP rs9331896; and

a T for the T/C SNP rs9331908; in the individual;

deducing that the individual is at risk of developing Alzheimer's disease if said at least one variation is present.

More preferably, it is deduced that the individual is at risk of developing Alzheimer's disease if it is determined that the individual presents a C for the C/T SNP, rs2279590, a C for the C/T SNP rs11136000, and a C or a G, preferably a G, for the C/G SNP rs9331888.

Still preferably, it is deduced that the individual is at risk of developing Alzheimer's disease if it is determined that the individual presents a T for the C/T SNP rs10091215, an A for the T/A SNP rs1073742, an A for the G/A SNP rs1073743, a T for the C/T SNP rs10780145, an A for the A/G SNP rs10866859, a T for the C/T SNP rs11136000, a T for the C/T SNP rs11787077, a T for the C/T SNP rs1532276, a T for the C/T SNP rs1532277, a T for the C/T SNP rs1532278, a G for the A/G SNP rs17057419, an A for the A/G SNP rs17466684, a T for the C/T SNP rs1982229, a C for the G/C SNP rs2070926, a T for the T/C SNP rs2279590, a T for the T/C SNP rs2279591, a C for the C/T SNP rs2582367, a G for the C/G SNP rs28558661, a C for the C/G SNP rs35810222, an A for the A/G SNP rs4236673, a C for the C/T SNP rs4352801, a G for the C/G SNP rs4732728, an A for the A/C SNP rs4732729, an A for the A/G SNP rs4732732, a C for the C/T SNP rs484377, a C for the G/C SNP rs485902, a T for the G/T SNP rs492638, a G for the G/T SNP rs495150, a T for the G/T SNP rs504038, a C for the C/T SNP rs507341, a G for the C/G SNP rs518317, an A for the A/G SNP rs520186, a G for the A/G SNP rs536332, a G for the A/G SNP rs538181, a T for the NT SNP rs569205, an A for the A/G SNP rs576748, a T for the C/T SNP rs6983452, a C for the C/T SNP rs7828131, an A for the G/A SNP rs7982, a C for the A/C SNP rs867230, a G for the A/G SNP rs9314349, a C for the T/C SNP rs9331896, a T for the T/C SNP rs9331908, an A for the SNP located at nucleotide position 27496798 of human chromosome 8, a T for the SNP located at nucleotide position 27498182 of human chromosome 8, a T for the SNP located at nucleotide position 27533395 of human chromosome 8, a G for the SNP located at nucleotide position 27542063 of human chromosome 8, a G for the SNP located at nucleotide position 27542086 of human chromosome 8, an A for the SNP located at nucleotide position 27542087 of human chromosome 8 and a T for the SNP located at nucleotide position 27542353 of human chromosome 8.

Still preferably, it is deduced that the individual is at risk of developing Alzheimer's disease if it is determined that the individual presents a T for the C/T SNP rs10091215, an A for the T/A SNP rs1073742, an A for the G/A SNP rs1073743, a T for the C/T SNP rs10780145, an A for the A/G SNP rs10866859, a T for the C/T SNP rs11136000, a T for the C/T SNP rs11787077, a T for the C/T SNP rs1532276, a T for the C/T SNP rs1532277, a T for the C/T SNP rs1532278, a G for the A/G SNP rs17057419, an A for the A/G SNP rs17466684, a T for the C/T SNP rs1982229, a C for the G/C SNP rs2070926, a T for the T/C SNP rs2279590, a T for the T/C SNP rs2279591, a C for the C/T SNP rs2582367, a G for the C/G SNP rs28558661, a C for the C/G SNP rs35810222, an A for the A/G SNP rs4236673, a C for the C/T SNP rs4352801, a G for the C/G SNP rs4732728, an A for the A/C SNP rs4732729, an A for the A/G SNP rs4732732, a C for the C/T SNP rs484377, a C for the G/C SNP rs485902, a T for the G/T SNP rs492638, a G for the G/T SNP rs495150, a T for the G/T SNP rs504038, a C for the C/T SNP rs507341, a G for the C/G SNP rs518317, an A for the A/G SNP rs520186, a G for the A/G SNP rs536332, a G for the A/G SNP rs538181, a T for the NT SNP rs569205, an A for the A/G SNP rs576748, a T for the C/T SNP rs6983452, a C for the C/T SNP rs7828131, an A for the G/A SNP rs7982, a C for the A/C SNP rs867230, a G for the A/G SNP rs9314349, a C for the T/C SNP rs9331896 and a T for the T/C SNP rs9331908.

Besides, where the susceptibility gene is CR1, the invention preferably comprises:

determining the presence or absence of at least one variation selected from the group consisting of:

an A for the A/G SNP rs6656401; and

an A for the A/G SNP rs3818361; in the individual;

deducing that the individual is at risk of developing Alzheimer's disease if said at least one variation is present.

Still preferably, where the susceptibility gene is CR1, the invention comprises:

determining the presence or absence of at least one variation selected from the group consisting of:

a C for the C/T SNP rs10779335;

a T for the G/T SNP rs10779336;

a T for the C/T SNP rs10863336;

an A for the A/T SNP rs10863417;

a C for the C/G SNP rs10863418;

an A for the A/C SNP rs10863420;

an A for the A/G SNP rs11576522;

an A for the A/G SNP rs11579070;

a T for the −/C/T SNP rs11803366;

a T for the C/T SNP rs11803956;

an A for the A/T SNP rs12028134;

an A for the A/G SNP rs12031281;

a G for the A/G SNP rs12032780;

a G for the A/G SNP rs12034383;

a C for the A/C SNP rs12036785;

a T for the G/T SNP rs12037841;

a G for the A/G SNP rs12038371;

a C for the A/C SNP rs12041437;

an A for the C/A SNP rs1408077;

a T for the T/C SNP rs1408078;

a T for the C/T SNP rs17186848;

a G for the A/G SNP rs17258982;

an A for the A/G SNP rs1752684;

a C for the C/A SNP rs1830763;

an A for the G/A SNP rs2093760;

an A for the G/A SNP rs2093761;

a C for the C/T SNP rs2182911;

a T for the A/T SNP rs2182912;

an A for the A/G SNP rs2182913;

a C for the C/T SNP rs2274566;

an A for the T/G/A SNP rs2296160;

a T for the C/T SNP rs3737002;

an A for the A/G SNP rs3738469;

an A for the G/A SNP rs3818361;

a T for the C/T SNP rs3849266;

an A for the A/G SNP rs3886100;

a T for the C/T SNP rs4266886;

a C for the −/C/T SNP rs4274065;

a C for the −/C/T SNP rs4310446;

a T for the C/T SNP rs4525038;

an A for the A/C SNP rs4562624;

a C for the C/T SNP rs4618970;

a C for the C/T SNP rs4618971;

a C for the C/G SNP rs4844383;

a C for the −/A/C/T SNP rs4844597;

an A for the A/C/G SNP rs4844600;

an A for the A/C SNP rs4844610;

a C for the A/C SNP rs6540433;

an A for the A/G SNP rs6656401;

a T for the C/T SNP rs6661489;

a G for the A/C/G SNP rs6661764;

an A for the A/G SNP rs6686325;

a C for the C/T SNP rs6690215;

a G for the −/A/G SNP rs6697005;

an A for the A/G SNP rs6701713;

a T for the C/T SNP rs679515;

a T for the C/T SNP rs7515905;

a G for the A/G SNP rs7519119;

a G for the C/G SNP rs7519408;

a C for the C/G SNP rs7525160;

a G for the A/G SNP rs7525170;

an A for the −/A/G SNP rs7533520;

a C for the A/C SNP rs7542544;

a G for the A/G SNP rs9429779;

a G for the C/G SNP rs9429780;

a G for the G/T SNP rs9429781;

a G for the A/G SNP rs9429784;

a T for the C/T SNP rs9429940;

a T for the A/T SNP rs9429941;

a C for the C/T SNP rs9429942;

a T for the −/C/T SNP rs9429945;

a C for the SNP located at nucleotide position 205717682 of human chromosome 1;

a T for the SNP located at nucleotide position 205734924 of human chromosome 1;

a G for the SNP located at nucleotide position 205762211 of human chromosome 1;

a G for the SNP located at nucleotide position 205796833 of human chromosome 1;

a T for the SNP located at nucleotide position 205857663 of human chromosome 1;

a G for the SNP located at nucleotide position 205862688 of human chromosome 1;

a T for the SNP located at nucleotide position 205867485 of human chromosome 1;

an A for the SNP located at nucleotide position 205877247 of human chromosome 1;

a T for the SNP located at nucleotide position 205878796 of human chromosome 1;

a T for the SNP located at nucleotide position 205879028 of human chromosome 1;

an A for the SNP located at nucleotide position 205886998 of human chromosome 1;

an A for the SNP located at nucleotide position 205888190 of human chromosome 1;

a G for the SNP located at nucleotide position 205892038 of human chromosome 1; and

a T for the SNP located at nucleotide position 205895594 of human chromosome 1, in the individual;

deducing that the individual is at risk of developing Alzheimer's disease if said at least one variation is present.

Still preferably, where the susceptibility gene is CR1, the invention comprises:

determining the presence or absence of at least one variation selected from the group consisting of:
a C for the C/T SNP rs10779335;

a T for the G/T SNP rs10779336;

a T for the C/T SNP rs10863336;

an A for the A/T SNP rs10863417;

a C for the C/G SNP rs10863418;

an A for the A/C SNP rs10863420;

an A for the A/G SNP rs11576522;

an A for the A/G SNP rs11579070;

a T for the −/C/T SNP rs11803366;

a T for the C/T SNP rs11803956;

an A for the A/T SNP rs12028134;

an A for the A/G SNP rs12031281;

a G for the A/G SNP rs12032780;

a G for the A/G SNP rs12034383;

a C for the A/C SNP rs12036785;

a T for the G/T SNP rs12037841;

a G for the A/G SNP rs12038371;

a C for the A/C SNP rs12041437;

an A for the C/A SNP rs1408077;

a T for the T/C SNP rs1408078;

a T for the C/T SNP rs17186848;

a G for the A/G SNP rs17258982;

an A for the A/G SNP rs1752684;

a C for the C/A SNP rs1830763;

an A for the G/A SNP rs2093760;

an A for the G/A SNP rs2093761;

a C for the C/T SNP rs2182911;

a T for the A/T SNP rs2182912;

an A for the A/G SNP rs2182913;

a C for the C/T SNP rs2274566;

an A for the T/G/A SNP rs2296160;

a T for the C/T SNP rs3737002;

an A for the A/G SNP rs3738469;

an A for the G/A SNP rs3818361;

a T for the C/T SNP rs3849266;

an A for the A/G SNP rs3886100;

a T for the C/T SNP rs4266886;
a C for the −/C/T SNP rs4274065;

a C for the −/C/T SNP rs4310446;

a T for the C/T SNP rs4525038;

an A for the A/C SNP rs4562624;

a C for the C/T SNP rs4618970;

a C for the C/T SNP rs4618971;

a C for the C/G SNP rs4844383;

a C for the −/A/C/T SNP rs4844597;

an A for the A/C/G SNP rs4844600;

an A for the A/C SNP rs4844610;

a C for the A/C SNP rs6540433;

an A for the A/G SNP rs6656401;

a T for the C/T SNP rs6661489;

a G for the A/C/G SNP rs6661764;

an A for the A/G SNP rs6686325;

a C for the C/T SNP rs6690215;

a G for the −/A/G SNP rs6697005;

an A for the A/G SNP rs6701713;

a T for the C/T SNP rs679515;

a T for the C/T SNP rs7515905;

a G for the A/G SNP rs7519119;

a G for the C/G SNP rs7519408;

a C for the C/G SNP rs7525160;

a G for the A/G SNP rs7525170;

an A for the −/A/G SNP rs7533520;

a C for the A/C SNP rs7542544;

a G for the A/G SNP rs9429779;

a G for the C/G SNP rs9429780;

a G for the G/T SNP rs9429781;

a G for the A/G SNP rs9429784;

a T for the C/T SNP rs9429940;

a T for the A/T SNP rs9429941;

a C for the C/T SNP rs9429942; and

a T for the −/C/T SNP rs9429945; in the individual;

deducing that the individual is at risk of developing Alzheimer's disease if said at least one variation is present.

More preferably, it is deduced that the individual is at risk of developing Alzheimer's disease if it is determined that the individual presents an A for the A/G SNP rs6656401, and a G or an A, preferably an A, for the A/G SNP rs3818361.

Still preferably, it is deduced that the individual is at risk of developing Alzheimer's disease if it is determined that the individual presents a C for the C/T SNP rs10779335, a T for the G/T SNP rs10779336, a T for the C/T SNP rs10863336, an A for the NT SNP rs10863417, a C for the C/G SNP rs10863418, an A for the A/C SNP rs10863420, an A for the A/G SNP rs11576522, an A for the A/G SNP rs11579070, a T for the −/C/T SNP rs11803366, a T for the C/T SNP rs11803956, an A for the NT SNP rs12028134, an A for the A/G SNP rs12031281, a G for the A/G SNP rs12032780, a G for the A/G SNP rs12034383, a C for the A/C SNP rs12036785, a T for the G/T SNP rs12037841, a G for the A/G SNP rs12038371, a C for the A/C SNP rs12041437, an A for the C/A SNP rs1408077, a T for the T/C SNP rs1408078, a T for the C/T SNP rs17186848, a G for the A/G SNP rs17258982, an A for the A/G SNP rs1752684, a C for the C/A SNP rs1830763, an A for the G/A SNP rs2093760, an A for the G/A SNP rs2093761, a C for the C/T SNP rs2182911, a T for the NT SNP rs2182912, an A for the A/G SNP rs2182913, a C for the C/T SNP rs2274566, an A for the T/G/A SNP rs2296160, a T for the C/T SNP rs3737002, an A for the A/G SNP rs3738469, an A for the G/A SNP rs3818361, a T for the C/T SNP rs3849266, an A for the A/G SNP rs3886100, a T for the C/T SNP rs4266886, a C for the −/C/T SNP rs4274065, a C for the −/C/T SNP rs4310446, a T for the C/T SNP rs4525038, an A for the A/C SNP rs4562624, a C for the C/T SNP rs4618970, a C for the C/T SNP rs4618971, a C for the C/G SNP rs4844383, a C for the −/A/C/T SNP rs4844597, an A for the A/C/G SNP rs4844600, an A for the A/C SNP rs4844610, a C for the A/C SNP rs6540433, an A for the A/G SNP rs6656401, a T for the C/T SNP rs6661489, a G for the A/C/G SNP rs6661764, an

A for the A/G SNP rs6686325, a C for the C/T SNP rs6690215, a G for the −/A/G SNP rs6697005, an A for the A/G SNP rs6701713, a T for the C/T SNP rs679515, a T for the C/T SNP rs7515905, a G for the A/G SNP rs7519119, a G for the C/G SNP rs7519408, a C for the C/G SNP rs7525160, a G for the A/G SNP rs7525170, an A for the −/A/G SNP rs7533520, a C for the A/C SNP rs7542544, a G for the A/G SNP rs9429779, a G for the C/G SNP rs9429780, a G for the G/T SNP rs9429781, a G for the A/G SNP rs9429784, a T for the C/T SNP rs9429940, a T for the NT SNP rs9429941, a C for the C/T SNP rs9429942, a T for the −/C/T SNP rs9429945, a C for the SNP located at nucleotide position 205717682 of human chromosome 1, a T for the SNP located at nucleotide position 205734924 of human chromosome 1, a G for the SNP located at nucleotide position 205762211 of human chromosome 1, a G for the SNP located at nucleotide position 205796833 of human chromosome 1, a T for the SNP located at nucleotide position 205857663 of human chromosome 1, a G for the SNP located at nucleotide position 205862688 of human chromosome 1, a T for the SNP located at nucleotide position 205867485 of human chromosome 1, an A for the SNP located at nucleotide position 205877247 of human chromosome 1, a T for the SNP located at nucleotide position 205878796 of human chromosome 1, a T for the SNP located at nucleotide position 205879028 of human chromosome 1, an A for the SNP located at nucleotide position 205886998 of human chromosome 1, an A for the SNP located at nucleotide position 205888190 of human chromosome 1, a G for the SNP located at nucleotide position 205892038 of human chromosome 1 and a T for the SNP located at nucleotide position 205895594 of human chromosome 1.

Still preferably, it is deduced that the individual is at risk of developing Alzheimer's disease if it is determined that the individual presents a C for the C/T SNP rs10779335, a T for the G/T SNP rs10779336, a T for the C/T SNP rs10863336, an A for the NT SNP rs10863417, a C for the C/G SNP rs10863418, an A for the A/C SNP rs10863420, an A for the A/G SNP rs11576522, an A for the A/G SNP rs11579070, a T for the −/C/T SNP rs11803366, a T for the C/T SNP rs11803956, an A for the NT SNP rs12028134, an A for the A/G SNP rs12031281, a G for the A/G SNP rs12032780, a G for the A/G SNP rs12034383, a C for the A/C SNP rs12036785, a T for the G/T SNP rs12037841, a G for the A/G SNP rs12038371, a C for the A/C SNP rs12041437, an A for the C/A SNP rs1408077, a T for the T/C SNP rs1408078, a T for the C/T SNP rs17186848, a G for the A/G SNP rs17258982, an A for the A/G SNP rs1752684, a C for the C/A SNP rs1830763, an A for the G/A SNP rs2093760, an A for the G/A SNP rs2093761, a C for the C/T SNP rs2182911, a T for the NT SNP rs2182912, an A for the A/G SNP rs2182913, a C for the C/T SNP rs2274566, an A for the T/G/A SNP rs2296160, a T for the C/T SNP rs3737002, an A for the A/G SNP rs3738469, an A for the G/A SNP rs3818361, a T for the C/T SNP rs3849266, an A for the A/G SNP rs3886100, a T for the C/T SNP rs4266886, a C for the −/C/T SNP rs4274065, a C for the −/C/T SNP rs4310446, a T for the C/T SNP rs4525038, an A for the A/C SNP rs4562624, a C for the C/T SNP rs4618970, a C for the C/T SNP rs4618971, a C for the C/G SNP rs4844383, a C for the −/A/C/T SNP rs4844597, an A for the A/C/G SNP rs4844600, an A for the A/C SNP rs4844610, a C for the A/C SNP rs6540433, an A for the A/G SNP rs6656401, a T for the C/T SNP rs6661489, a G for the A/C/G SNP rs6661764, an A for the A/G SNP rs6686325, a C for the C/T SNP rs6690215, a G for the −/A/G SNP rs6697005, an A for the A/G SNP rs6701713, a T for the C/T SNP rs679515, a T for the C/T SNP rs7515905, a G for the A/G SNP rs7519119, a G for the C/G SNP rs7519408, a C for the C/G SNP rs7525160, a G for the A/G SNP rs7525170, an A for the −/A/G SNP rs7533520, a C for the A/C SNP rs7542544, a G for the A/G SNP rs9429779, a G for the C/G SNP rs9429780, a G for the G/T SNP rs9429781, a G for the A/G SNP rs9429784, a T for the C/T SNP rs9429940, a T for the NT SNP rs9429941, a C for the C/T SNP rs9429942 and a T for the −/C/T SNP rs9429945.

The above-defined variations are well known to one of skill in the art and are notably described in the NCBI database dbSNP (www.ncbi.nlm.nih.gov/SNP/). When the above-defined variations are defined by the location of the SNP on a human chromosome, said location corresponds to the one described in the databases HG18/NCBI 36.3. It is thus within the general knowledge of the skilled person to obtain the sequences of the above-defined variations from their locations on the chromosomes.

As will be clear to one of skill in the art, a C/T, C/G or A/G SNP read on a first nucleic acid strand is respectively identical to a A/G, C/G or C/T SNP read on the complementary strand to said first nucleic acid strand.

For the purpose of unambiguously identifying the above variations, the sequences flanking the above-defined variations are notably represented by the following sequences wherein the variation is shown between square brackets:

rs2279590:
(SEQ ID NO: 5)
CTTCTGATAAGGAAGTCCTCCTGCT[C/T]CTCCAAGGAAACCTAGAGA
GCTGACC
rs11136000:
(SEQ ID NO: 6)
CACCAAAGCCACACCAGCTATCAAAA[C/T]TCTCTAACGGGCCCTTGC
CACTTGA
rs9331888:
(SEQ ID NO: 7)
AGAGCAAGAGGACTCATCCTTCCAAA[C/G]GGACTTTCTCTGGGAAGC
CTGCTCC
rs6656401:
(SEQ ID NO: 8)
ATTTCCTTCTCTGTCTCCATCTTCTC[A/G]TCGCCTTCTCCTCTGTGT
GTGTCCT
rs3818361:
(SEQ ID NO: 9)
AGCCCTCTGGTAAGCATAAGATATA[A/G]CAAAGGAAATTGCCCCATA
TCTAACA
rs10091215:
(SEQ ID NO: 10)
TCACCGTGGTCTCGATATCCTGACCT[C/T]GTGATCCACTCGCCTCGG
CCTCCCA
rs1073742:
(SEQ ID NO: 11)
TCCAGCCTGGGCAACAGAGTGCGAC[T/A]CTGTCTCTAAAAAGAAAAA
AATAATT
rs1073743:
(SEQ ID NO: 12)
TTGGCTCATGCCTGTAATCACAGCA[G/A]TCTGGGAGGCTGAGGCAAG
AGGATCA
rs10780145:
(SEQ ID NO: 13)
AGCTGATGCCTATATATTGCTTGCCA[C/T]GTGCCTGACCATTTTAAA
CACCTTC
rs10866859:
(SEQ ID NO: 14)
CAGTAGCTGATGCCTATATATTGCTT[A/G]CCACGTGCCTGACCATTT
TAAACAC
rs11787077:
(SEQ ID NO: 15)
CCACACCCCAGAGTTAGGTGAGGTCT[C/T]GTCCTGCTCCATCATCCC
CTGTCC
rs1532276:
(SEQ ID NO: 16)
CTGTCTGGGCCCCTGCCGCCACCCCA[C/T]CCAGAGCCTGCTTGGAAC
TAGCATG
rs1532277:
(SEQ ID NO: 17)
CATCCAGAGCCTGCTTGGAACTAGCA[C/T]GTGATCAGGGCTTAGAAA
CATCTAT
rs1532278:
(SEQ ID NO: 18)
GCAAATGAACCTTCCCTGCTTCTTAA[C/T]TGCAGCCTCAGCATCAGC
TGACACA
rs17057419:
(SEQ ID NO: 19)
GTCTCCTCTGGTGGAGGAAAGCTCTA[A/G]TAGGACCCTGCAGTGCCA
GGTCCGC
rs17466684:
(SEQ ID NO: 20)
AGAACTACTGGATACTTCCTGGGTTT[A/G]CCACTATCCTATTTTCTA
GTGGGGC
rs1982229:
(SEQ ID NO: 21)
ATTCTGGACCTCATCTCTCTTGAAAC[C/T]CTTGGCCCAGCCCTGGAC
TAGCCAA
rs2070926:
(SEQ ID NO: 22)
CACGCAGAGCCTGAACCAGGGGCCT[G/C]GGAGCTGAGGCTCAGAGTG
GGCCCAG
rs2279591:
(SEQ ID NO: 23)
CTGCTCCCCCTTTGCCACAAGAGTC[T/C]TAGAAGCCAGACACTAAGG
GCTCAGG
rs2582367:
(SEQ ID NO: 24)
TACAGGCATGAGCCACCACTCCCAGC[C/T]GTAACTACATAGCTTAAA
AACAATA
rs28558661:
(SEQ ID NO: 25)
ACAGAGTGAGACTCTGTCTCGGGGGG[C/G]GGGGGGGGGGGGAAGCAG
CAACCAA
rs35810222:
(SEQ ID NO: 26)
GGCCAGGCTGGTCTTGAACTCCTGAC[C/G]TCAAGTAATCTGCCCGCC
TCGGCCT
rs4236673:
(SEQ ID NO: 27)
AGGAATCCCCTGACAAAGAAAAAGAT[A/G]CTTAAAAATATTTGAAAC
AGTATTA
rs4352801:
(SEQ ID NO: 28)
TTCCTCTGGTTCCCACACAGCGAGAA[C/T]GTCAGTGCCATCCACCAG
GACCACA
rs4732728:
(SEQ ID NO: 29)
TGGCCAGGCTGGTCCCCAAGACACCA[C/G]AGAGCATCTGCCTAGAAA
GAGGCAA
rs4732729:
(SEQ ID NO: 30)
GCGCTTGGCGCTTGGGAACAGAATCA[A/C]CGGGGAGTCCCAGGGGGA
TGACTTT
rs4732732:
(SEQ ID NO: 31)
CAAAAATTAGCTGGGCATGGTGGCAC[A/G]CGCCTGCAGTCCCAGCTA
CTCGGGA
rs484377:
(SEQ ID NO: 32)
TTTTGGTTTTGTTTTGTTTTTTAATA[C/T]GGAGCTCATCCCGTCGCC
CAGCCTG
rs485902:
(SEQ ID NO: 33)
ACTGGGCAAGTGCCCCAAGAGGTGG[G/C]CTTTCAATGTCGGAGAGCC
AAAAAAC
rs492638:
(SEQ ID NO: 34)
AAAGTGACCCTTTGTGTGTTGTCAGT[G/T]TTTTTCCAACCAGATTAT
CATTTTT
rs495150:
(SEQ ID NO: 35)
AAGGTTCATAGGTATTAACTTGACCC[G/T]ATTAAGCCCTCTTTGAAG
ATTTATC
rs504038:
(SEQ ID NO: 36)
CAGCTACTCAGGAAGCTGAGATGGAG[G/T]ATCGCTTGAGCCCAGGAG
GTCAAGG
rs507341:
(SEQ ID NO: 37)
TGAAGACAGAGATGTTTCCAGTCCTA[C/T]TTGCAGTAACCTAAAATT
GCAGGAC
rs518317:
(SEQ ID NO: 38)
AAATATTATTTTATTTATTTATTTTT[C/G]AGACAGGGTCTCACTCTG
TCACCCA
rs520186:
(SEQ ID NO: 39)
GTTTTCAACTATTTATTTTTAAATAA[A/G]ATTTCCCCTCTGTCACTT
GTCTATC
rs536332:
(SEQ ID NO: 40)
CTGCATAGTATTCCATGGTGTATACC[A/G]TAGTATTCCATGGTGTAT
ATATACC
rs538181:
(SEQ ID NO: 41)
TTCTGAGTGATTTTCTCCGGACCTCC[A/G]TAAAGTCCAGAAACATTC
ACTCCAT
rs569205:
(SEQ ID NO: 42)
TGTATTTCACTCCAGAGTTGCTTTAC[A/T]GTGACCTTTAGCTCCAAT
TATTAGG
rs576748:
(SEQ ID NO: 43)
GGAAGAGATCAATTTCCCTGAGCACT[A/G]AGGGCTGATACTATGTTC
TCAGGAG
rs6983452:
(SEQ ID NO: 44)
CTTTATAACAGCATTATTTACAATAG[C/T]CAAATGTCTTATCAAGAC
AAATGGA
rs7828131:
(SEQ ID NO: 45)
CAGGGGAGGGGGACTACAGGTGGCAC[C/T]AGAGGGACCCCACTAAAC
AAACCAT
rs7982:
(SEQ ID NO: 46)
TTGGCGGGTGCTGGAAGGCCGGGCT[G/A]TGGAAGTGGATGTCCATGG
CCTGCTG
rs867230:
(SEQ ID NO: 47)
CGATCATGTCAGACACTGAAAATACC[A/C]CCCTTAGGTCATGCATCC
GTCCCTC
rs9314349:
(SEQ ID NO: 48)
TTTCATATTCTAAGCAGATCATAGAC[A/G]TTGATTGGTTCAGGACTC
ACACACT
rs9331896:
(SEQ ID NO: 49)
AGCTCCGGTGGTCCAGACACAGCTT[T/C]GTGGAGGAGGCCTGGGAGC
TGGGCTA
rs9331908:
(SEQ ID NO: 50)
GTGGACACAGGGCTCTGCCATCCCA[T/C]GAAGCAGTTTATTATGTCA
TCCAGCT
rs10779335:
(SEQ ID NO: 51)
GTGGCAGAAAGAAAGATCATGATCCT[C/T]GTTAGACTTAAAGGTCAG
GGATGTA
rs10779336:
(SEQ ID NO: 52)
TCCTCGTTAGACTTAAAGGTCAGGGA[G/T]GTAAACCTCCCAAACATC
TATGTAA
rs10863336:
(SEQ ID NO: 53)
GTTACTACAACTGAAGGACGGAAGGG[C/T]TTCCAGCCTCTAGTAGGT
AGAGGCC
rs10863417:
(SEQ ID NO: 54)
AGTGAGCCAAGACTGTGCCATTGCAC[A/T]CCAGCCTGGGTGACAGAG
TGAGACT
rs10863418:
(SEQ ID NO: 55)
CTAATTTTCTGTATCTATATCAGTCT[C/G]TAGTTAAAACCACACAGG
GGAAATG
rs10863420:
(SEQ ID NO: 56)
GAAGGAAGCCATGTGGGAAACACAGA[A/C]TATGAGTGGAGAGTATCG
TAGTGGT
rs11576522:
(SEQ ID NO: 57)
ATTTGGGTATCTCTTCCTAAATTCAT[A/G]TCAAACTAGAAGCATCAA
TTGCTTT
rs11579070:
(SEQ ID NO: 58)
CAGGACCAGTTGAGTCATGAGTCACA[A/G]GTCCAGGTAGAGTCAGTC
AGTTGCC
rs11803366:
(SEQ ID NO: 59)
TGTTTTCTTTTCCATGCTAAATTAAC[-/C/T]TCTGATGAATAGAGAC
AATTTTTTA
rs11803956:
(SEQ ID NO: 60)
TAACTCTTCAAGCTTCCATTCTAAAA[C/T]CCCTAATACCAACTCATA
CATAAAA
rs12028134:
(SEQ ID NO: 61)
GAAAAACATAAATAAATAAATTAAAT[A/T]AAATAAAACAAGAAAAGA
AACTAAA
rs12031281:
(SEQ ID NO: 62)
ATCCCTGCACTTTGGGAGGCTGAGGC[A/G]GGTGGGTCACCTGAGGTC
AGGAGTT
rs12032780:
(SEQ ID NO: 63)
ACCAGCTACTCGGGAGGTTGAAGCAT[A/G]AGAATTGCTTGAACCCAG
GAGGCAG
rs12034383:
(SEQ ID NO: 64)
AAATTATGTCAGAAATAGTGAAATGT[A/G]TTAAGGCATGGACATCTG
CCTATAA
rs12036785:
(SEQ ID NO: 65)
AACATGGTACTCCTGTTCCCTCACAG[A/C]GTGACCCCAGTGGCTCCA
GGGCTAG
rs12037841:
(SEQ ID NO: 66)
TACTTTCTTTTTTTTTTTTGATACAA[G/T]GTCTTGCTTTGTTGCCCA
GGCTGGA
rs12038371:
(SEQ ID NO: 67)
CCAAGAGGAAGGTTCTTTAAAGAGCT[A/G]TGCTCAGGATGGTCTTTC
TGTTGTA
rs12041437:
(SEQ ID NO: 68)
CCTGTGAAATGGAGATAATAATAGTT[A/C]CTACCTTACTTAACATAG
TGCCTCA
rs1408077:
(SEQ ID NO: 69)
TATTGGATTATTATTGTCATTTCCA[C/A]TGTTTTGGGGTGATGACTC
TATAAGT
rs1408078:
(SEQ ID NO: 70)
TGACATGACCCCACCCCCACATTCC[T/C]AGTCTCTCTTATCCTGCTT
TATTTTT
rs17186848:
(SEQ ID NO: 71)
ACTATGAGAAATTTCTCACTGGCTAG[C/T]TCCCCTTTTAACCTGGGC
TTTCCAT
rs17258982:
(SEQ ID NO: 72)
TGATACTTCTTACCTTCTTGATTGTC[A/G]TTACCTTATACGTGATAT
CAAAACA
rs1752684:
(SEQ ID NO: 73)
AGCTCAAGACCAGCCTAGACAACATG[A/G]CAAAAACCCATCTCTACA
AAAAAGT
rs1830763:
(SEQ ID NO: 74)
CAAAGGCAAAACTCCATCTGAAAAA[C/A]ATAAATAAATAAATTAAAT
AAAATAA
rs2093760:
(SEQ ID NO: 75)
ACCAAATGGGAAGAGAGGTTCTCAA[G/A]CCAGTCCATGGATTTACCT
GGAACTT
rs2093761:
(SEQ ID NO: 76)
GTGGAGAAGAGTTTTATTGAGTGAC[G/A]AAACAGCTTCTCAGCGGAG
ACGAGAC
rs2182911:
(SEQ ID NO: 77)
AATTTTAAGACAGTGACAGTAGGATT[C/T]GTGGATAGTTTGTATCAG
AATATGA
rs2182912:
(SEQ ID NO: 78)
AAAATTTGGGCTTTGTCATCATGTGG[A/T]TGTACATAACAAGGAGAC
TGAATAA
rs2182913:
(SEQ ID NO: 79)
AACAAGGAGACTGAATAAGATCTCCG[A/G]GAAGTGAAAGAGGCTAGC
AAAAAGA
rs2274566:
(SEQ ID NO: 80)
ATTACCTGAATAACAATGGTACAAAT[C/T]GGGATTACCTTCCTAGGA
AATATGT
rs2296160:
(SEQ ID NO: 81)
TGTGACTTTTGTCTTCCTTTTAGGT[T/G/A]CACATGATGCTCTCTCA
TAGTTGGTAAG
rs3737002:
(SEQ ID NO: 82)
AGAGCAGTTTCCATTTGCCAGTCCTA[C/T]GATCCCAATTAATGACTT
TGAGTTT
rs3738469:
(SEQ ID NO: 83)
GGCGCTAAGACTCAATTTCACACTAC[A/G]CGCCCAGGCCACGCCCAC
CTGTCAT
rs3849266:
(SEQ ID NO: 84)
CTCGCCCCTCAATCTGCATTGATCCA[C/T]TCCTTAATTTACATGTAA
CCGAAAT
rs3886100:
(SEQ ID NO: 85)
AATTGGGGCTGGGCCTTAGATTGTGA[A/G]CTAAGTGTCCTCTTGGCT
GAAACAG
rs4266886:
(SEQ ID NO: 86)
TTTATGTGGAAAAAGAATCAGATGAA[C/T]GGCATATATGGCAAGATC
TCACTTT
rs4274065:
(SEQ ID NO: 87)
CAGTGTCCACATGTATAAAATGAGCA[-/C/T]AACTGACATCCTGATC
TCTGAGAGA
rs4310446:
(SEQ ID NO: 88)
GCGGTTTGCCTAAGACCTCATAGCCA[-/C/T]TAAGTAGAAGACATTG
GGTTCAAGA
rs4525038:
(SEQ ID NO: 89)
CCTCAAGGTTCATTAATGTTGTAGCA[C/T]GTGTCAGAATTTCTTTCC
TTTTTAA
rs4562624:
(SEQ ID NO: 90)
AAATGTTACTTTTACTAGAAAGTTTA[A/C]GAGCTTCAGAATCTAAGT
TTACAAA
rs4618970:
(SEQ ID NO: 91)
TGGCAAAGGTGGAATGCAAGCTCATG[C/T]CTGAGTTTAAACTGCTTT
CTCCTAC
rs4618971:
(SEQ ID NO: 92)
AGAAACCATAGTCTTCCAGAATCACA[C/T]TGAACTATGGGAAAGAGG
GGATTTC
rs4844383:
(SEQ ID NO: 93)
ATGCTGGGAAGTCCTGTGAAATGGAA[C/G]GAGAACGAAGATGAGGAA
TCTGGTG
rs4844597:
(SEQ ID NO: 94)
ATGCTGATGGATGCTTCCAGTGTGCA[-/A/C/T]GGTCCTTTGGAATT
TTAAAGAAGTA
rs4844600:
(SEQ ID NO: 95)
GCCAGGCCTACCAACCTAACTGATGA[A/C/G]TTTGAGTTTCCCATTG
GGACATATC
rs4844610:
(SEQ ID NO: 96)
CCCATTTCTACACAAAACAGCCTTGT[A/C]CACAGTCAAAATTTCAAA
GTTTCCA
rs6540433:
(SEQ ID NO: 97)
CTTATACGTGATATCAAAACACAGAG[A/C]ACGGTAAGTTCAAAGGCG
AATACTT
rs6661489:
(SEQ ID NO: 98)
CCACCGTGCCCGGCCTCTATGTTTTA[C/T]AGAGAATATGTGCCTTAG
ACACATC
rs6661764:
(SEQ ID NO: 99)
TAATGTCTCCATTTTCGCCATACTTT[A/C/G]TATGTCCTACATAGCA
GCCATCACA
rs6686325:
(SEQ ID NO: 100)
TTCTATGCTCACAGTGTAAACAAAGC[A/G]CCAGGGAAGCCTGAACTG
GGTGGAG
rs6690215:
(SEQ ID NO: 101)
TTTGGTGAGGATGCAAAGCAAATGGT[C/T]AATATTTGGGAGTTTTAA
TCAGGAA
rs6697005:
(SEQ ID NO: 102)
AGTATTCTTAAGCTTCTTTGCATATT[-/A/G]TTAGACATTTGCATAT
ACACCTTGA
rs6701713:
(SEQ ID NO: 103)
TGATAATGCCTGCAGCCCAACAGATG[A/G]CAGTGTGCTTAACAGCTC
TGTCAAT
rs679515:
(SEQ ID NO: 104)
GCTGAGATCACGCCACTGCACTCCAG[C/T]GTGGGGAACAGAGTGAGG
ATCTGTT
rs7515905:
(SEQ ID NO: 105)
CACCAGAATCACTTGAACCTGGGAGG[C/T]GGAGTTTGCAGTGAGCCG
AGATGGC
rs7519119:
(SEQ ID NO: 106)
AGGAATGGGCTCTGAGCAGTGCTGGC[A/G]GCTGGACCAGGCATGTCG
CACTGAA
rs7519408:
(SEQ ID NO: 107)
CAGTGAATAGAAAGCAAATTATTCAG[C/G]TGAGAGTGAGGCTCAGAA
AGGAGGT
rs7525160:
(SEQ ID NO: 108)
AAGGTTTAAAGTCAAAATTATTTTAA[C/G]AGAAAAACCCAGGCAAAA
TAGCCTA
rs7525170:
(SEQ ID NO: 109)
ACCCAGGCAAAATAGCCTACCTACAG[A/G]CAGGCAGTACATGTCAGA
AGGACAG
rs7533520:
(SEQ ID NO: 110)
GATAACAATACATACCCACTAGAATG[-/A/G]CTAAAATGAAAAAGAT
TGACCGAGG
rs7542544:
(SEQ ID NO: 111)
AACAGGGGTGCCCATGACCCCAAAGC[A/C]CAGAGGAGGTGTTACAGC
ACACTAA
rs9429779:
(SEQ ID NO: 112)
ATGGAGGAAGGCAAAGGGGAAGCAAG[A/G]CATCTCATACGGTGGGAG
CAGGAGG
rs9429780:
(SEQ ID NO: 113)
AGCCACATTCAGTTTCACAGGTATGA[C/G]AGCAAAATAATGGAGAAT
TGATTCT
rs9429781:
(SEQ ID NO: 114)
AATAATGGAGAATTGATTCTAACCAG[G/T]AATGTTGTTTTGTCTAAT
GGCTATA
rs9429784:
(SEQ ID NO: 115)
TCTCCACATGCCAGTGATTTCTGTTC[A/G]TTTTTCTTTATCTCCAGT
GAAATCC
rs9429940:
(SEQ ID NO: 116)
GAAGCATTTTCTGGGGTTATGATGGC[C/T]TTACCTTTATTAGGAAGT
ATGGTTT
rs9429941:
(SEQ ID NO: 117)
CAGTGGGTGCAAGATGGTGATTATAA[A/T]GACAGAGTATGGAATTTA
ACCTGGT
rs9429942:
(SEQ ID NO: 118)
CACAACGTGCAGGTTTGTTACATATG[C/T]ATACATGTGCGACGTTGG
TGTGCTG
rs9429945:
(SEQ ID NO: 119)
ATGTATTCTCTTCCAGTTCTGGAGGC[-/C/T]GACGTCTAAAATAGAT
CCATAGGGC

Preferably also, in the above-defined method, it is deduced that the individual is at risk of developing Alzheimer's disease as defined above if said individual is homozygous for the at least one variant allele or for the at least one variation.

As intended herein the expression “homozygous” means that the at least one variant allele or the at least one variation is present for the two genomic copies of the gene.

As intended herein, the expression “risk factor for Alzheimer's disease” relates to all characteristics of an individual, in particular of a genetic, environmental, or physiological nature, which are known to be predictive of Alzheimer's disease as defined above. Numerous risk factors for Alzheimer's disease are known in the art.

However, it preferred within the frame of the present invention that the at least one other risk factor for Alzheimer's disease is a variant allele of the apolipoprotein E gene.

Variant alleles of the apolipoprotein E gene constituting a risk factor for Alzheimer's disease as defined above are well known to one of skill in the art and notably encompass the ε4 allele of APOE, in particular as described by Farrer et al. (Farrer et al. (1997) JAMA 278:1349-1356.).

### Example 1

### Methods

### AD Samples

All AD cases were ascertained by neurologists from Bordeaux, Dijon, Lille, Montpellier, Paris, Rouen, and were identified as French Caucasian. Clinical diagnosis of probable AD was established according to the DSM-III-R and NINCDS-ADRDA criteria (McKhann et al. (1984) Neurology 34:939-944). Written informed consent was obtained from study participants or, for those with substantial cognitive impairment, from a caregiver, legal guardian, or other proxy, and the study protocols for all populations were reviewed and approved by the appropriate Institutional review boards. Genomic DNA samples from 2,344 AD cases were available for analysis prior to genotype quality control steps.

### Control Samples

Controls were selected from the 3C Study (Alpérovitch et al. (2003) Neuroepidemiology 22:316-325). This cohort is a population-based, prospective (4-years follow-up) study of the relationship between vascular factors and dementia. It has been carried out in three French cities: Bordeaux (southwest France), Montpellier (southeast France) and Dijon (central eastern France). A sample of non-institutionalised, over-65 subjects was randomly selected from the electoral rolls of each city. Between January 1999 and March 2001, 9,686 subjects meeting the inclusion criteria agreed to participate. Following recruitment, 392 subjects withdrew from the study. Thus, 9,294 subjects were finally included in the study (2,104 in Bordeaux, 4,931 in Dijon and 2,259 in Montpellier). At 4 years of follow-up, three hundred and fifty individuals were demented, with 143 prevalent cases (91 cases of AD, 39 cases of mixed/vascular dementia, 3 cases of Parkinsonian dementia and 10 cases of other types of dementia) and 207 incident cases (135 cases of AD, 40 cases of mixed/vascular dementia, 15 cases of Parkinsonian dementia and 17 cases of other types of dementia). Prevalent and incident AD cases were included as cases. Patients with other types of dementia, and individuals for whom information on their dementia status during the 4-year follow-up was missing were excluded (n=854; refusal or lost to follow-up and death). At this stage, genomic DNA samples of 7,076 controls were available from the 3C study prior to genotype quality control steps. Supplementary control data on additional anonymised samples were used in some analyses as explained in the text below (Heath et al. (2009) Eur. J. Hum. Genet. 16:1413-29).

### Genotyping

DNA samples were transferred to the French Centre National de Génotypage (CNG) for genotyping. First stage samples that passed DNA quality control were genotyped with Illumina Human 610-Quad BeadChips. Genotype data were retained in the study for samples that had been successfully genotyped for >98% of the SNP markers. SNPs with call rate <98%, with minor allele frequency (MAF)<1% or exhibiting departure from the Hardy-Weinberg equilibrium in the control population (p<10−6) were excluded. 134 AD cases and 980 controls samples were removed because they were found to be first- or second-degree relatives of other study participations, or were assessed non-Caucasian based on genetic analysis using methods described in Heath et al. (2009) Eur. J. Hum. Genet. 16:1413-29. 537,029 autosomal SNPs genotyped in 2,032 cases and 5,328 controls were thus retained. In order to avoid any genotyping bias, cases and controls were randomly mixed when genotyping, and laboratory personnel were blinded to case/control status. Genotyping success rate was at least 95%, and no departure from Hardy-Weinberg equilibrium was observed for the markers included in the second stage.

### Statistical Analysis

The case and control differences were evaluated using a logistic regression, which optionally incorporated principal components that were significantly associated with disease status to account for possible population stratification as described in Heath et al. (2009) Eur. J. Hum. Genet. 16:1413-29 and Price et al. (2006) Nat. Genet. 38:904-909. It was hypothesized that the relatively high genomic control without the adjustment with principal components was due to differences in representation of various French regions in the case and control series. Therefore, the robustness of the conclusions were further explored through incorporation of 6,734 anonymised samples from France and other European countries as additional controls (Heath et al. (2009) Eur. J. Hum. Genet. 16:1413-29). With the inclusion of the additional samples, the genomic control parameter was 1.04 without adjustment with principal components, and 1.03 after adjustment. The inclusion of the additional controls did not substantially modify the association statistics for markers in regions showing suggestive evidence of association (p<10−5) after correction for population structure in the primary analysis. Statistical analyses were undertaken under an additive genetic model using logistic regression taking account of age, sex and disease status using SAS software release 9.1 (SAS Institute, Cary, N.C.). Population controls that were not genotyped specifically for this study were excluded, as were any samples with missing age or gender data. This gave a maximum of 2,025 AD cases and 5,328 controls. Information on age and gender in the cases and controls included in these analyses are shown in Table 1.

TABLE 1
population characteristics

| | AD cases | Controls |
|---|---|---|
| n | 2025 | 5328 |
| Mean age | 73.7 ± 8.9 | |
| Mean age at onset | 68.3 ± 9.0 | — |
| % male | 34 | 39 |

Interactions between APOJ or CR1 SNPs and APOE ε4 polymorphism were tested in logistic regression models adjusted for age, gender and centres. The solid spine haplotype block definition in Haploview 4.0 was used to generate linkage disequilibrium blocks of the genomic regions encompassing the APOJ or CR1 genes from imputed SNPs (MAF>5%) (Barrett et al. (2005) Bioinformatics 21:263-5). Associations of the APOJ and CR1 haplotypes were estimated using logistic regression or proportional hazards models using Thesias 3.0 which implements a maximum likelihood model and uses a SEM algorithm (Tregouet & Tiret (2004) Eur. J. Hum. Genet. 12:971-974). The population attributable risk fraction was estimated using the formula: PAR=F(OR-1)/(F(OR-1)+1) where F is the frequency of the deleterious allele in the sample and OR the odds ratio of AD risk associated to the deleterious allele.

### URLs

Haploview: http://www.broad.mit.edu/mpg/haploview/index.php
Revman: http://www.cc-ims.net/revman/
Thesias: http://ecgene.net/genecanvas/uploads/THESIAS3.1/
HapMap: http://www.hapmap.org

### Results

### Study of Late-Onset AD

A genome-wide association (GWA) analysis of 537,029 SNPs in 2,032 French AD cases and 5,328 French controls was undertaken. Patients with probable AD according to DSM-III-R and NINCDS-ADRDA criteria were ascertained by neurologists. Individuals without symptoms of dementia from French Three-City (3C) prospective population-based cohort (described in Methods) were obtained as controls. The study samples were genotyped with Illumina Human 610-Quad BeadChip, and subjected to standard quality controls procedures (see Methods).

The resulting GWA data were then analyzed for association with a logistic regression taking into sex and age, and using principal components to adjust for possible population stratification as described (see Methods). Prior to adjustment for possible population stratification the genomic control parameter was 1.20, but after adjustment it became 1.04. The observed versus expected X² distribution (quantile-quantile plots) did not indicate substantial inflation of the test statistics after adjustment. Additional tests were undertaken to establish the robustness of the statistical results as described in the Methods.

Several APOE-linked SNPs gave strong evidence of disease association (Table 2).

TABLE 2
Association statistics from the GWA at the APOE locus.
Frequency (Reference allele)

| | | | | | supp. | | | |
|---|---|---|---|---|---|---|---|---|
| rs | Chr | Pos (bp) | cases | controls | controls | Analysis 1 | Analysis 2 | Analysis 3 |
| 2965109 | 19 | 49917185 | — | — | — | 1.70E−09 | 1.60E−07 | — |
| 7254776 | 19 | 49919582 | — | — | — | 2.80E−09 | 1.50E−07 | — |
| 2927488 | 19 | 49923318 | 0.764 | 0.723 | 0.741 | 5.06E−07 | 5.42E−06 | 1.78E−05 |
| 2965101 | 19 | 49929652 | 0.691 | 0.634 | 0.653 | 6.87E−11 | 3.84E−09 | 8.54E−10 |
| 17728272 | 19 | 49932211 | — | — | — | 2.70E−07 | 3.10E−06 | — |
| 8100239 | 19 | 49944944 | — | — | — | 2.00E−09 | 3.60E−08 | — |
| 8103315 | 19 | 49946008 | — | — | — | 5.70E−07 | 5.10E−06 | — |
| 4803759 | 19 | 50019299 | — | — | — | 5.10E−07 | 2.20E−06 | — |
| 10402271 | 19 | 50021054 | 0.626 | 0.696 | 0.695 | 6.44E−16 | 1.90E−14 | <2e−16 |
| 7408909 | 19 | 50023565 | — | — | — | 1.30E−14 | 7.90E−14 | — |
| 7359852 | 19 | 50027875 | — | — | — | <2e−16 | <2e−16 | — |
| 2927480 | 19 | 50029225 | — | — | — | <2e−16 | <2e−16 | — |
| 1871047 | 19 | 50043586 | 0.64 | 0.597 | 0.591 | 1.59E−06 | 9.41E−07 | 1.10E−07 |
| 1871046 | 19 | 50043777 | — | — | — | 1.60E−06 | 6.80E−07 | — |
| 4803763 | 19 | 50049131 | — | — | — | <2e−16 | <2e−16 | — |
| 440277 | 19 | 50053064 | — | — | — | 8.80E−11 | 2.60E−09 | — |
| 12978931 | 19 | 50055540 | — | — | — | 7.80E−06 | 5.20E−06 | — |
| 6859 | 19 | 50073874 | 0.49 | 0.42 | 0.424 | 1.07E−13 | 1.01E−12 | 4.95E−15 |
| 11669338 | 19 | 50074824 | — | — | — | 1.70E−11 | 1.20E−09 | — |
| 11673139 | 19 | 50074877 | — | — | — | 1.70E−11 | 1.20E−09 | — |
| 3852861 | 19 | 50074901 | — | — | — | 9.50E−06 | 9.50E−06 | — |
| 3745150 | 19 | 50077599 | — | — | — | <2e−16 | <2e−16 | — |
| 283813 | 19 | 50081014 | — | — | — | 2.90E−07 | 7.20E−07 | — |
| 6857 | 19 | 50084094 | — | — | — | <2e−16 | <2e−16 | — |
| 157580 | 19 | 50087106 | 0.288 | 0.402 | 0.412 | <2e−16 | <2e−16 | <2e−16 |
| 2075650 | 19 | 50087459 | 0.727 | 0.899 | 0.884 | <2e−16 | <2e−16 | <2e−16 |
| 157583 | 19 | 50088513 | — | — | — | 4.40E−08 | 7.20E−06 | — |
| 8106922 | 19 | 50093506 | 0.672 | 0.57 | 0.598 | <2e−16 | <2e−16 | <2e−16 |
| 10119 | 19 | 50098513 | — | — | — | <2e−16 | <2e−16 | — |
| 405509 | 19 | 50100676 | 0.542 | 0.458 | 0.479 | <2e−16 | <2e−16 | <2e−16 |
| 439401 | 19 | 50106291 | 0.28 | 0.391 | 0.391 | <2e−16 | <2e−16 | <2e−16 |
| 4420638 | 19 | 50114786 | — | — | — | <2e−16 | <2e−16 | — |
| 4803770 | 19 | 50119193 | — | — | — | 2.40E−16 | 2.60E−15 | — |
| 5112 | 19 | 50122120 | — | — | — | 1.40E−08 | 9.40E−07 | — |
| 12721108 | 19 | 50139081 | — | — | — | 1.10E−07 | 2.80E−06 | — |

Markers are shown when p < 10⁻⁵ in analysis 1.
Analysis 1 = GWA cases vs. study controls, logistic regression (age, gender adjusted);
Analysis 2 = GWA cases vs. study controls, logistic regression with principal components adjustment;
Analysis 3 = GWA cases vs. study and supplementary controls, logistic regression and principal components adjustment.

Outside of APOE, one marker, rs11136000, within the apolipoprotein J gene (APOJ) on chromosome 8p21-p12 gave P=9.0×10⁻⁸ in the association test. This slightly surpassed the criteria for genome-wide significance as evaluated with a conservative Bonferroni correction (P<9.3×10⁻⁸). Markers in several chromosome regions were observed with suggestive evidence of association (P<10⁻⁵) as shown in Table 3. Finally, imputation of genotypes using the HapMap CEU samples to increase the number of SNPs examined in these regions was undertaken. The genotyped and imputed markers from the regions that gave P<10⁻⁵ in the original case/control comparison are shown in Table 3.

TABLE 3
Results from the GWA for regions containing markers with p < 10⁻⁵ in analysis 1.
Frequency (Reference allele)

| | | | | | supp. | | | |
|---|---|---|---|---|---|---|---|---|
| rs | Chr | Pos (bp) | cases | controls | controls | Analysis 1 | Analysis 2 | Analysis 3 |
| 2182912 | 1 | 205726967 | — | — | — | 5.30E−05 | 6.19E−05 | — |
| 4844597 | 1 | 205737892 | — | — | — | 4.70E−05 | 5.79E−05 | — |
| 4274065 | 1 | 205738099 | — | — | — | 4.70E−05 | 5.90E−05 | — |
| 9429945 | 1 | 205743391 | — | — | — | 8.99E−05 | 1.70E−04 | — |
| 6656401 | 1 | 205758672 | — | — | — | 6.40E−05 | 1.10E−04 | — |
| 3818361 | 1 | 205851591 | 0.217 | 0.179 | 0.199 | 2.35E−07 | 2.87E−06 | 5.96E−06 |
| 6701713 | 1 | 205852912 | 0.217 | 0.179 | 0.2 | 2.40E−07 | 2.89E−06 | 6.39E−06 |
| 2296160 | 1 | 205861943 | — | — | — | 2.90E−07 | 3.40E−06 | — |
| 1408078 | 1 | 205867178 | — | — | — | 2.90E−07 | 3.40E−06 | — |
| 4844610 | 1 | 205869175 | — | — | — | 8.89E−07 | 9.29E−06 | — |
| 1408077 | 1 | 205870764 | 0.212 | 0.176 | 0.198 | 3.68E−07 | 4.72E−06 | 9.05E−06 |
| 11952762 | 5 | 118383450 | 0.953 | 0.93 | 0.945 | 3.64E−07 | 6.62E−06 | 0.000144 |
| 11959554 | 5 | 118399338 | — | — | — | 3.30E−06 | 4.60E−05 | — |
| 12201301 | 6 | 31115536 | 0.969 | 0.982 | 0.974 | 1.46E−06 | 3.88E−06 | 4.96E−05 |
| 11768400 | 7 | 84893471 | — | — | — | 3.10E−05 | 7.00E−07 | — |
| 6465004 | 7 | 84894842 | — | — | — | 3.10E−05 | 7.10E−07 | — |
| 11762648 | 7 | 84915141 | — | — | — | 5.30E−05 | 1.70E−06 | — |
| 12704129 | 7 | 84917284 | — | — | — | 2.70E−05 | 7.91E−07 | — |
| 11769386 | 7 | 84921805 | — | — | — | 2.90E−05 | 8.20E−07 | — |
| 2462051 | 7 | 84937706 | — | — | — | 6.90E−04 | 1.20E−05 | — |
| 2462049 | 7 | 84937834 | — | — | — | 5.00E−04 | 1.10E−05 | — |
| 2463670 | 7 | 84942229 | — | — | — | 3.30E−06 | 1.80E−07 | — |
| 13231722 | 7 | 84953822 | — | — | — | 6.00E−04 | 2.40E−05 | — |
| 10499889 | 7 | 84959000 | 0.535 | 0.572 | 0.55 | 5.20E−05 | 4.54E−06 | 0.000305 |
| 6951823 | 7 | 84998691 | — | — | — | 3.10E−04 | 1.10E−05 | — |
| 10252600 | 7 | 85015874 | — | — | — | 3.70E−04 | 1.30E−05 | — |
| 12334143 | 7 | 85020952 | — | — | — | 8.00E−06 | 8.00E−07 | — |
| 12333397 | 7 | 85020998 | — | — | — | 1.40E−05 | 1.80E−06 | — |
| 3087554 | 8 | 27511359 | — | — | — | 1.00E−04 | 2.80E−04 | — |
| 2279590 | 8 | 27512170 | — | — | — | 5.00E−06 | 4.90E−07 | — |
| 11136000 | 8 | 27520436 | 0.346 | 0.389 | 0.379 | 1.32E−06 | 8.99E−08 | 1.94E−08 |
| 9331888 | 8 | 27524779 | — | — | — | 1.20E−06 | 3.10E−06 | — |
| 12931878 | 16 | 10949695 | — | — | — | 1.10E−05 | 1.70E−04 | — |
| 8055533 | 16 | 10949740 | 0.652 | 0.693 | 0.679 | 1.70E−06 | 1.25E−06 | 7.06E−06 |
| 4781028 | 16 | 10966864 | — | — | — | 8.59E−06 | 1.30E−04 | — |
| 9302457 | 16 | 10967338 | — | — | — | 7.50E−07 | 2.20E−06 | — |
| 16957843 | 16 | 10968706 | — | — | — | 9.71E−05 | 4.30E−04 | — |
| 16957849 | 16 | 10972808 | — | — | — | 7.40E−06 | 1.20E−04 | — |

All markers with p < 10−4 in analysis 1 are shown for these regions.
Markers with allele frequencies absent and no results for analysis 3 have been imputed.
Analysis 1 = GWA cases vs. study controls, logistic regression (age, gender adjusted);
Analysis 2 = GWA cases vs. study controls, logistic regression with principal components adjustment;
Analysis 3 = GWA cases vs. study and supplementary controls, logistic regression and principal components adjustment.

### APOJ

At APOJ on 8p21-p12, four SNPs (rs3087554, rs2279590, rs11136000 and rs9331888) were tested that showed evidence of association and were not in complete LD. Three of these markers (rs2279590, rs11136000 and rs9331888) exhibited statistically significant association with AD (Table 4). Strong evidence for association was found in the GWA datasets taking into account the sample origin in the logistic regression, with two markers exceeding the criterion for genome-wide significance (P<9.3×10⁻⁸). For the marker showing the strongest evidence of association (rs11136000), the odds ratio for the minor allele was 0.86 (95% Cl 0.81-0.90, P=7.5×10⁻⁹).

The effect of the APOJ locus taking into account APOE ε4 status in cases and controls was also examined (Table 4).

TABLE 4
Association of SNPs at the APOJ locus with AD.

| | N | | MAF | | | Association test | |
|---|---|---|---|---|---|---|---|
| | Cases | Controls | Cases | Controls | HW | OR (95% CI) | P value |
| rs2279590 | 2025 | 5328 | 0.36 | 0.41 | 3 · 1 · 10⁻¹ | 0.83 | 1 · 0 · 10⁻⁶ |
| | | | | | | (0.77-0.90) | |
| rs11136000 | 2016 | 5266 | 0.35 | 0.39 | 6 · 0 · 10⁻¹ | 0.83 | 1 · 5 · 10⁻⁶ |
| | | | | | | (0.77-0.90) | |
| rs9331888 | 2025 | 5328 | 0.31 | 0.28 | 8 · 9 · 10⁻¹ | 1.19 | 1 · 8 · 10⁻⁵ |
| | | | | | | (1.11-1.30) | |

P values and odds ratios (OR) with their 95% confidence interval (95% CI) have been calculated under an additive model using logistic regression models adjusted for age, gender and centres when necessary.
MAF = minor allele frequency;
HW = P value for the test of Hardy Weinberg Equilibrium in controls.

A statistical interaction between the APOE ε4 status and the APOJ SNPs (ranging from 3.0×10⁻² to 5.2×10⁻² according to the SNP tested) was detected. For rs11136000, while the association was significant in both ε4 carriers and non-carriers, it was greater in carriers (OR=0.81, P=2.7×10⁻⁵ in carriers, OR=0.91 P=7.0×10⁻³ in non-carriers). Analysis of the GWA data showed that these markers are within a LD block that encompasses only the APOJ gene. The three APOJ locus markers define three common haplotypes (frequency>2%) that together account for 98.2% of the observations in controls. Compared to the most frequent TTC haplotype, the other two frequent haplotypes were all associated with a statistically significant increased disease risk (Table 5). The odds ratio was highest for the CCG haplotype compared to the TTC haplotype, with the following AD risk and association p-values: OR=1.28, P=1.5×10⁻⁷.

TABLE 5

| Haplotypes | Cases | Controls | OR (95% CI) | P values |
|---|---|---|---|---|
| TTC | 0.344 | 0.388 | Ref. | — |
| CCC | 0.334 | 0.329 | 1.14 (1.04-1.24) | 3.0.10⁻³ |
| CCG | 0.302 | 0.265 | 1.28 (1.17-1.41) | 1.5.10⁻⁷ |

Association results for haplotypes at the APOJ locus. The results have been calculated using the Thesias programme with adjustment for age, gender and centre. The P value for the global association was 1.8.10⁻⁶. The markers as ordered from left to right (5′ to 3′) are rs2279590, rs11136000 and rs9331888. Minor alleles are underlined.

### CR1

A second locus of potential interest lies within a LD block that encompasses CR1 on 1q32. Two SNPs were tested at this locus (rs6656401 and rs3818361) which showed evidence of association with disease (Table 6).

TABLE 6
Association of SNPs at the CR1 locus with AD.

| | N | | MAF | | | Association test | |
|---|---|---|---|---|---|---|---|
| | Cases | Controls | Cases | Controls | HW | OR (95% CI) | P value |
| rs6654601 | 2025 | 5324 | 0.22 | 0.18 | 9 · 9 · 10⁻¹ | 1.27 | 1 · 8 · 10⁻⁷ |
| | | | | | | (1.16-1.39) | |
| Rs3818361 | 2018 | 5324 | 0.22 | 0.18 | 8 · 5 · 10⁻¹ | 1.28 | 8 · 5 · 10⁻⁸ |
| | | | | | | (1.17-1.40) | |

P values and odds rations (OR) with their 95% confidence interval (95% CI) have been calculated under an additive model using logistic regression models adjusted for age, gender and centres when necessary.
MAF = minor allele frequency;
HW = P value for the test of Hardy Weinberg Equilibrium in controls.

At this locus, a statistical interaction with APOE ε4 status and risk of disease (P=9.6.10⁻³) was also detected with significant association in both carrier and non-carriers but stronger in the former. For rs6656401, OR=1.38 (95% Cl 1.22-1.55) in carriers, OR=1.13 (95% 1.04-1.23) in non-carriers was obtained. There was evidence association of the rs3818361 SNP in the APOE ε4 carriers (OR=1.38 95% Cl 1.19-1.60, P=2.3.10⁻⁵).

The genotyped markers define two principal haplotypes that account for 97.8% of the observations at the CR1 locus, while a third haplotype has an estimated frequency of 1.2% in the combined control population (Table 7). The odds ratio was highest for the AA haplotype compared to the GG haplotype, with the following AD risk and association p-values: OR=1.28, P=1.4×10⁻⁷.

TABLE 7

| Haplotypes | Cases | Controls | OR (95% CI) | P values |
|---|---|---|---|---|
| GG | 0.772 | 0.813 | Ref. | — |
| GA | 0.011 | 0.009 | 1.25 (0.87-1.80) | 2.2.10⁻¹ |
| AA | 0.207 | 0.170 | 1.28 (1.17-1.40) | 1.4.10⁻⁷ |

Association results for haplotypes at the CR1 locus. The results have been calculated using the Thesias programme with adjustment for age, gender and centre. The P value for the global association was 7.5.10⁻⁷. The markers as ordered from left to right (5′ to 3′) are rs6656401 and rs3818361. Minor alleles are underlined.

The attributable fraction of risk was calculated to be 25.5% for APOE, 8.9% for APOJ and 3.8% for CR1. If the estimate that 60-80% of the AD risk is due to genetic factors is correct, additional genetic susceptibility loci still remain to be identified. This situation is similar to that of many other diseases in which loci have been successfully mapped by GWA.

In summary, in addition to the previously known APOE locus, new loci at APOJ and CR1 have been identified that are potentially associated with the risk of late-onset AD.

### Example 2

Applying the same approach as the one described in Example 1 on the 1000 genome project panel: pilot 1, CEU, the inventors identified other SNPs at the APOJ locus and at the CR1 locus that were associated with Alzheimer's disease. The SNPs at the APOJ locus are referenced in Table 8 and the SNPs at the CR1 locus are referenced in Table 9.

TABLE 8
Association of SNPs at the APOJ locus with AD.

| rs | Chr | Pos (bp) | Allele | Strand | MAF | Rsq | OR [CI] | p-value |
|---|---|---|---|---|---|---|---|---|
| 10091215 | 8 | 27507636 | T | + | 0.222059 | 0.7988 | 1.1 | 4.32E−02 |
| | | | | | | | [1.01; 1.19] | |
| 1073742 | 8 | 27536374 | A | − | 0.451584 | 0.9138 | 0.9 | 3.88E−03 |
| | | | | | | | [0.83; 0.97] | |
| 1073743 | 8 | 27536129 | A | − | 0.459537 | 0.9069 | 0.9 | 6.40E−03 |
| | | | | | | | [0.82; 0.98] | |
| 10780145 | 8 | 27490639 | T | + | 0.439375 | 0.8642 | 1.12 | 3.91E−03 |
| | | | | | | | [1.04; 1.2] | |
| 10866859 | 8 | 27490635 | A | + | 0.172597 | 0.9949 | 1.13 | 1.48E−02 |
| | | | | | | | [1.03; 1.23] | |
| 11136000 | 8 | 27520436 | T | + | 0.37561 | 0.9804 | 0.8 | 4.73E−08 |
| | | | | | | | [0.72; 0.88] | |
| 11318062 | 8 | 27533396 | C | + | 0.008581 | 0.2691 | 0.51 | 5.20E−03 |
| | | | | | | | [0.04; 0.98] | |
| 11787077 | 8 | 27521229 | T | + | 0.386424 | 0.8485 | 0.8 | 2.03E−08 |
| | | | | | | | [0.72; 0.88] | |
| 1532276 | 8 | 27522074 | T | + | 0.386424 | 0.8427 | 0.8 | 2.09E−08 |
| | | | | | | | [0.72; 0.88] | |
| 1532277 | 8 | 27522098 | T | + | 0.386424 | 0.8421 | 0.8 | 2.09E−08 |
| | | | | | | | [0.72; 0.88] | |
| 1532278 | 8 | 27522232 | T | + | 0.385238 | 0.82 | 0.8 | 1.47E−08 |
| | | | | | | | [0.72; 0.88] | |
| 17057419 | 8 | 27493305 | G | + | 0.172597 | 0.9968 | 1.13 | 1.48E−02 |
| | | | | | | | [1.03; 1.23] | |
| 17466684 | 8 | 27508764 | A | + | 0.131785 | 0.4109 | 1.17 | 5.06E−03 |
| | | | | | | | [1.06; 1.28] | |
| 1982229 | 8 | 27530518 | T | + | 0.374494 | 0.822 | 1.11 | 7.88E−03 |
| | | | | | | | [1.03; 1.19] | |
| 2070926 | 8 | 27523738 | C | − | 0.382238 | 0.702 | 0.79 | 8.57E−09 |
| | | | | | | | [0.71; 0.87] | |
| 2279590 | 8 | 27512170 | T | − | 0.386633 | 0.7866 | 0.81 | 1.48E−07 |
| | | | | | | | [0.73; 0.89] | |
| 2279591 | 8 | 27509680 | T | − | 0.233501 | 0.5168 | 1.17 | 6.19E−04 |
| | | | | | | | [1.08; 1.26] | |
| 2582367 | 8 | 27535944 | C | + | 0.461699 | 0.9201 | 0.91 | 1.05E−02 |
| | | | | | | | [0.83; 0.99] | |
| 28558661 | 8 | 27510265 | G | + | 0.24857 | 0.5194 | 1.14 | 2.90E−03 |
| | | | | | | | [1.05; 1.23] | |
| 35810222 | 8 | 27516103 | C | | 0.373308 | 0.6737 | 1.24 | 8.25E−08 |
| | | | | | | | [1.16; 1.32] | |
| 4236673 | 8 | 27520846 | A | + | 0.379866 | 0.9365 | 0.8 | 4.12E−08 |
| | | | | | | | [0.72; 0.88] | |
| 4352801 | 8 | 27491118 | C | + | 0.426748 | 0.9877 | 1.1 | 1.16E−02 |
| | | | | | | | [1.02; 1.18] | |
| 4732728 | 8 | 27497438 | G | + | 0.416492 | 0.8116 | 1.1 | 1.18E−02 |
| | | | | | | | [1.02; 1.18] | |
| 4732729 | 8 | 27517409 | A | + | 0.398493 | 0.6849 | 1.24 | 7.45E−08 |
| | | | | | | | [1.16; 1.32] | |
| 4732732 | 8 | 27532345 | A | + | 0.490512 | 0.8735 | 1.09 | 1.96E−02 |
| | | | | | | | [1.01; 1.17] | |
| 484377 | 8 | 27533428 | C | + | 0.455281 | 0.8927 | 0.9 | 6.26E−03 |
| | | | | | | | [0.82; 0.98] | |
| 485902 | 8 | 27545878 | C | − | 0.448165 | 0.9449 | 0.91 | 1.02E−02 |
| | | | | | | | [0.83; 0.99] | |
| 492638 | 8 | 27535146 | T | + | 0.305846 | 0.9976 | 0.9 | 1.11E−02 |
| | | | | | | | [0.82; 0.98] | |
| 495150 | 8 | 27538273 | G | + | 0.307242 | 0.9961 | 0.9 | 1.08E−02 |
| | | | | | | | [0.82; 0.98] | |
| 504038 | 8 | 27531239 | T | + | 0.416981 | 0.8728 | 0.91 | 1.19E−02 |
| | | | | | | | [0.83; 0.99] | |
| 507341 | 8 | 27537903 | C | + | 0.330403 | 0.9693 | 0.89 | 5.23E−03 |
| | | | | | | | [0.81; 0.97] | |
| 518317 | 8 | 27535664 | G | + | 0.396819 | 0.7495 | 0.91 | 2.36E−02 |
| | | | | | | | [0.83; 0.99] | |
| 520186 | 8 | 27535022 | A | + | 0.457932 | 0.9214 | 0.91 | 1.21E−02 |
| | | | | | | | [0.83; 0.99] | |
| 536332 | 8 | 27531686 | G | + | 0.457653 | 0.8988 | 0.91 | 1.09E−02 |
| | | | | | | | [0.83; 0.99] | |
| 538181 | 8 | 27532734 | G | + | 0.455281 | 0.8899 | 0.9 | 6.26E−03 |
| | | | | | | | [0.82; 0.98] | |
| 569205 | 8 | 27532938 | T | + | 0.412237 | 0.8856 | 0.89 | 3.52E−03 |
| | | | | | | | [0.81; 0.97] | |
| 576748 | 8 | 27542835 | A | + | 0.325171 | 0.9068 | 0.9 | 1.07E−02 |
| | | | | | | | [0.82; 0.98] | |
| 6983452 | 8 | 27503945 | T | + | 0.432887 | 0.7783 | 1.13 | 1.89E−03 |
| | | | | | | | [1.05; 1.21] | |
| 7828131 | 8 | 27496927 | C | + | 0.39926 | 0.9966 | 1.09 | 2.31E−02 |
| | | | | | | | [1.01; 1.17] | |
| 7982 | 8 | 27518398 | A | − | 0.377145 | 0.9212 | 0.8 | 5.92E−08 |
| | | | | | | | [0.72; 0.88] | |
| 867230 | 8 | 27524420 | C | + | 0.37861 | 0.7045 | 0.79 | 1.28E−08 |
| | | | | | | | [0.71; 0.87] | |
| 9314349 | 8 | 27530121 | G | + | 0.381192 | 0.9749 | 1.1 | 1.86E−02 |
| | | | | | | | [1.02; 1.18] | |
| 9331896 | 8 | 27523603 | C | − | 0.382238 | 0.7027 | 0.79 | 8.57E−09 |
| | | | | | | | [0.71; 0.87] | |
| 9331908 | 8 | 27519535 | T | − | 0.366541 | 0.6772 | 1.24 | 6.32E−08 |
| | | | | | | | [1.16; 1.32] | |
| | 8 | 27496798 | A | | 0.0400446 | 0.334 | 0.77 | 1.01E−02 |
| | | | | | | | [0.57; 0.97] | |
| | 8 | 27498182 | T | | 0.173015 | 0.9923 | 1.12 | 2.18E−02 |
| | | | | | | | [1.02; 1.22] | |
| | 8 | 27533395 | T | | 0.008581 | 0.2688 | 0.51 | 5.20E−03 |
| | | | | | | | [0.04; 0.98] | |
| | 8 | 27542063 | G | | 0.0125576 | 0.4057 | 0.68 | 4.12E−02 |
| | | | | | | | [0.31; 1.05] | |
| | 8 | 27542086 | G | | 0.0347426 | 0.4618 | 0.74 | 6.89E−03 |
| | | | | | | | [0.52; 0.96] | |
| | 8 | 27542087 | A | | 0.0385098 | 0.4555 | 0.78 | 1.64E−02 |
| | | | | | | | [0.58; 0.98] | |
| | 8 | 27542353 | T | | 0.00634854 | 0.3569 | 0.54 | 2.47E−02 |
| | | | | | | | [0; 1.08] | |

TABLE 9
Association of SNPs at the CR1 locus with AD.

| rs | Chr | Pos (bp) | Allele | Strand | MAF | Rsq | OR [CI] | p-value |
|---|---|---|---|---|---|---|---|---|
| 10779335 | 1 | 205865317 | C | + | 0.185922 | 0.9938 | 1.25 | 3.96E−06 |
| | | | | | | | [1.16; 1.34] | |
| 10779336 | 1 | 205865339 | T | + | 0.187945 | 0.9251 | 1.24 | 5.01E−06 |
| | | | | | | | [1.15; 1.33] | |
| 10863336 | 1 | 205732543 | T | + | 0.290428 | 0.8185 | 0.87 | 1.50E−03 |
| | | | | | | | [0.79; 0.95] | |
| 10863417 | 1 | 205863520 | A | + | 0.185922 | 0.9928 | 1.25 | 3.96E−06 |
| | | | | | | | [1.16; 1.34] | |
| 10863418 | 1 | 205864861 | C | + | 0.18934 | 0.8956 | 1.26 | 9.74E−07 |
| | | | | | | | [1.17; 1.35] | |
| 10863420 | 1 | 205866497 | A | + | 0.185922 | 0.9942 | 1.25 | 3.96E−06 |
| | | | | | | | [1.16; 1.34] | |
| 11576522 | 1 | 205855892 | A | + | 0.379866 | 0.9842 | 1.14 | 6.18E−04 |
| | | | | | | | [1.06; 1.22] | |
| 11579070 | 1 | 205865764 | A | + | 0.388656 | 0.9483 | 1.13 | 1.77E−03 |
| | | | | | | | [1.05; 1.21] | |
| 11803366 | 1 | 205873612 | T | + | 0.400726 | 0.9197 | 1.13 | 1.24E−03 |
| | | | | | | | [1.05; 1.21] | |
| 11803956 | 1 | 205869644 | T | + | 0.400726 | 0.9575 | 1.13 | 1.23E−03 |
| | | | | | | | [1.05; 1.21] | |
| 12028134 | 1 | 205867032 | A | + | 0.403725 | 0.8918 | 1.12 | 2.50E−03 |
| | | | | | | | [1.04; 1.2] | |
| 12031281 | 1 | 205866777 | A | + | 0.271313 | 0.5949 | 0.91 | 3.04E−02 |
| | | | | | | | [0.82; 1] | |
| 12032780 | 1 | 205863461 | G | + | 0.400656 | 0.961 | 1.13 | 1.33E−03 |
| | | | | | | | [1.05; 1.21] | |
| 12034383 | 1 | 205870218 | G | + | 0.400726 | 0.9573 | 1.13 | 1.23E−03 |
| | | | | | | | [1.05; 1.21] | |
| 12036785 | 1 | 205859532 | C | + | 0.374913 | 0.9104 | 1.14 | 6.91E−04 |
| | | | | | | | [1.06; 1.22] | |
| 12037841 | 1 | 205750815 | T | + | 0.194642 | 0.6068 | 1.23 | 1.12E−05 |
| | | | | | | | [1.14; 1.32] | |
| 12038371 | 1 | 205887669 | G | + | 0.272708 | 0.8065 | 0.9 | 1.82E−02 |
| | | | | | | | [0.82; 0.98] | |
| 12041437 | 1 | 205869887 | C | + | 0.400726 | 0.9574 | 1.13 | 1.23E−03 |
| | | | | | | | [1.05; 1.21] | |
| 1408077 | 1 | 205870764 | A | − | 0.185922 | 0.996 | 1.25 | 3.96E−06 |
| | | | | | | | [1.16; 1.34] | |
| 1408078 | 1 | 205867178 | T | − | 0.220315 | 0.849 | 1.22 | 1.18E−05 |
| | | | | | | | [1.13; 1.31] | |
| 17186848 | 1 | 205871506 | T | + | 0.400795 | 0.9231 | 1.13 | 1.28E−03 |
| | | | | | | | [1.05; 1.21] | |
| 17258982 | 1 | 205719987 | G | + | 0.0743686 | 0.9565 | 1.22 | 4.52E−03 |
| | | | | | | | [1.08; 1.36] | |
| 1752684 | 1 | 205813919 | A | + | 0.379238 | 0.7949 | 1.15 | 2.98E−04 |
| | | | | | | | [1.07; 1.23] | |
| 1830763 | 1 | 205867012 | C | − | 0.185922 | 0.9947 | 1.25 | 3.96E−06 |
| | | | | | | | [1.16; 1.34] | |
| 2093760 | 1 | 205853451 | A | − | 0.198061 | 0.7983 | 1.22 | 2.51E−05 |
| | | | | | | | [1.13; 1.31] | |
| 2093761 | 1 | 205853165 | A | − | 0.218292 | 0.8 | 1.22 | 1.95E−05 |
| | | | | | | | [1.13; 1.31] | |
| 2182911 | 1 | 205726694 | C | + | 0.202386 | 0.9618 | 1.2 | 9.55E−05 |
| | | | | | | | [1.11; 1.29] | |
| 2182912 | 1 | 205726967 | T | + | 0.196735 | 0.9962 | 1.22 | 3.46E−05 |
| | | | | | | | [1.13; 1.31] | |
| 2182913 | 1 | 205727001 | A | + | 0.32245 | 0.9969 | 1.11 | 9.94E−03 |
| | | | | | | | [1.03; 1.19] | |
| 2274566 | 1 | 205819968 | C | + | 0.407841 | 0.8606 | 1.13 | 9.24E−04 |
| | | | | | | | [1.06; 1.2] | |
| 2296160 | 1 | 205861943 | A | − | 0.18927 | 0.9252 | 1.25 | 2.65E−06 |
| | | | | | | | [1.16; 1.34] | |
| 35659754 | 1 | 205891262 | T | + | 0.0115809 | 0.2587 | 0.68 | 4.45E−02 |
| | | | | | | | [0.3; 1.06] | |
| 3737002 | 1 | 205827396 | T | + | 0.277173 | 0.5634 | 0.91 | 2.32E−02 |
| | | | | | | | [0.82; 1] | |
| 3738469 | 1 | 205885045 | A | + | 0.0696247 | 0.9198 | 1.17 | 2.85E−02 |
| | | | | | | | [1.03; 1.31] | |
| 3818361 | 1 | 205851591 | A | − | 0.190038 | 0.9998 | 1.25 | 2.57E−06 |
| | | | | | | | [1.16; 1.34] | |
| 3849266 | 1 | 205819613 | T | + | 0.274173 | 0.5378 | 0.9 | 1.35E−02 |
| | | | | | | | [0.81; 0.99] | |
| 3886100 | 1 | 205805750 | A | + | 0.407632 | 0.6457 | 1.13 | 1.23E−03 |
| | | | | | | | [1.05; 1.21] | |
| 4266886 | 1 | 205752409 | T | + | 0.189968 | 0.6183 | 1.24 | 1.02E−05 |
| | | | | | | | [1.14; 1.34] | |
| 4274065 | 1 | 205738099 | C | + | 0.196596 | 0.9713 | 1.22 | 3.12E−05 |
| | | | | | | | [1.13; 1.31] | |
| 4310446 | 1 | 205743227 | C | + | 0.192549 | 0.9937 | 1.19 | 2.08E−04 |
| | | | | | | | [1.1; 1.28] | |
| 4525038 | 1 | 205730560 | T | + | 0.125087 | 0.9975 | 1.15 | 1.53E−02 |
| | | | | | | | [1.04; 1.26] | |
| 4562624 | 1 | 205752588 | A | + | 0.18648 | 0.6931 | 1.24 | 1.26E−05 |
| | | | | | | | [1.14; 1.34] | |
| 4618970 | 1 | 205728263 | C | + | 0.125087 | 1 | 1.15 | 1.53E−02 |
| | | | | | | | [1.04; 1.26] | |
| 4618971 | 1 | 205732684 | C | + | 0.244524 | 0.9516 | 1.17 | 3.34E−04 |
| | | | | | | | [1.08; 1.26] | |
| 4844383 | 1 | 205874544 | C | + | 0.258965 | 0.5906 | 0.9 | 2.07E−02 |
| | | | | | | | [0.81; 0.99] | |
| 4844597 | 1 | 205737892 | C | + | 0.196596 | 0.9715 | 1.22 | 3.12E−05 |
| | | | | | | | [1.13; 1.31] | |
| 4844600 | 1 | 205745930 | A | + | 0.179782 | 0.6831 | 1.24 | 1.59E−05 |
| | | | | | | | [1.14; 1.34] | |
| 4844610 | 1 | 205869175 | A | + | 0.185922 | 0.9954 | 1.25 | 3.96E−06 |
| | | | | | | | [1.16; 1.34] | |
| 6540433 | 1 | 205720018 | C | + | 0.168829 | 0.9886 | 1.2 | 3.20E−04 |
| | | | | | | | [1.1; 1.3] | |
| 6656401 | 1 | 205758672 | A | + | 0.18641 | 0.7022 | 1.24 | 1.20E−05 |
| | | | | | | | [1.15; 1.33] | |
| 6661489 | 1 | 205764667 | T | + | 0.189549 | 0.7203 | 1.24 | 1.21E−05 |
| | | | | | | | [1.15; 1.33] | |
| 6661764 | 1 | 205875008 | G | + | 0.276894 | 0.7135 | 0.9 | 1.58E−02 |
| | | | | | | | [0.82; 0.98] | |
| 6686325 | 1 | 205899980 | A | + | 0.268732 | 0.7374 | 0.92 | 4.36E−02 |
| | | | | | | | [0.84; 1] | |
| 6690215 | 1 | 205722673 | C | + | 0.438468 | 0.9994 | 1.12 | 2.66E−03 |
| | | | | | | | [1.04; 1.2] | |
| 6697005 | 1 | 205873353 | G | + | 0.185922 | 0.9387 | 1.25 | 3.96E−06 |
| | | | | | | | [1.16; 1.34] | |
| 6701713 | 1 | 205852912 | A | + | 0.190038 | 0.9998 | 1.25 | 2.57E−06 |
| | | | | | | | [1.16; 1.34] | |
| 679515 | 1 | 205817191 | T | + | 0.200014 | 0.6682 | 1.24 | 3.20E−06 |
| | | | | | | | [1.15; 1.33] | |
| 7515905 | 1 | 205804700 | T | + | 0.18927 | 0.7359 | 1.23 | 1.25E−05 |
| | | | | | | | [1.14; 1.32] | |
| 7519119 | 1 | 205852775 | G | + | 0.406376 | 0.9916 | 1.13 | 1.63E−03 |
| | | | | | | | [1.05; 1.21] | |
| 7519408 | 1 | 205727912 | G | + | 0.125017 | 0.9996 | 1.15 | 1.45E−02 |
| | | | | | | | [1.04; 1.26] | |
| 7525160 | 1 | 205735037 | C | + | 0.290638 | 0.8059 | 0.88 | 2.77E−03 |
| | | | | | | | [0.8; 0.96] | |
| 7525170 | 1 | 205735070 | G | + | 0.196735 | 0.9813 | 1.22 | 2.83E−05 |
| | | | | | | | [1.13; 1.31] | |
| 7533520 | 1 | 205740568 | A | + | 0.196944 | 0.9521 | 1.22 | 2.74E−05 |
| | | | | | | | [1.13; 1.31] | |
| 7542544 | 1 | 205852846 | C | + | 0.406376 | 0.9915 | 1.13 | 1.63E−03 |
| | | | | | | | [1.05; 1.21] | |
| 9429779 | 1 | 205731344 | G | + | 0.30466 | 0.9696 | 1.13 | 3.30E−03 |
| | | | | | | | [1.05; 1.21] | |
| 9429780 | 1 | 205733813 | G | + | 0.217315 | 0.9145 | 1.17 | 6.18E−04 |
| | | | | | | | [1.08; 1.26] | |
| 9429781 | 1 | 205733845 | G | + | 0.217315 | 0.9144 | 1.17 | 6.18E−04 |
| | | | | | | | [1.08; 1.26] | |
| 9429784 | 1 | 205766383 | G | | 0.189828 | 0.7048 | 1.24 | 1.03E−05 |
| | | | | | | | [1.15; 1.33] | |
| 9429940 | 1 | 205729535 | T | + | 0.125087 | 1 | 1.15 | 1.53E−02 |
| | | | | | | | [1.04; 1.26] | |
| 9429941 | 1 | 205733926 | T | + | 0.245151 | 0.8949 | 1.17 | 4.03E−04 |
| | | | | | | | [1.08; 1.26] | |
| 9429942 | 1 | 205735253 | C | + | 0.327752 | 0.8495 | 1.1 | 1.86E−02 |
| | | | | | | | [1.02; 1.18] | |
| 9429945 | 1 | 205743391 | T | + | 0.192898 | 0.8999 | 1.19 | 2.58E−04 |
| | | | | | | | [1.1; 1.28] | |
| | 1 | 205717682 | C | | 0.0104646 | 0.5224 | 0.65 | 3.19E−02 |
| | | | | | | | [0.25; 1.05] | |
| | 1 | 205734924 | T | | 0.0232315 | 0.3693 | 0.7 | 9.86E−03 |
| | | | | | | | [0.43; 0.97] | |
| | 1 | 205762211 | G | | 0.00690666 | 0.5665 | 0.58 | 3.17E−02 |
| | | | | | | | [0.08; 1.08] | |
| | 1 | 205796833 | G | | 0.280243 | 0.5951 | 1.18 | 1.06E−04 |
| | | | | | | | [1.1; 1.26] | |
| | 1 | 205857663 | T | | 0.468746 | 0.6578 | 1.11 | 6.36E−03 |
| | | | | | | | [1.03; 1.19] | |
| | 1 | 205862688 | G | | 0.373029 | 0.9739 | 1.14 | 5.91E−04 |
| | | | | | | | [1.06; 1.22] | |
| | 1 | 205867485 | T | | 0.287847 | 0.6527 | 0.91 | 2.48E−02 |
| | | | | | | | [0.83; 0.99] | |
| | 1 | 205877247 | A | | 0.0618808 | 0.6939 | 1.18 | 3.19E−02 |
| | | | | | | | [1.03; 1.33] | |
| | 1 | 205878796 | T | | 0.0655783 | 0.7041 | 1.17 | 4.56E−02 |
| | | | | | | | [1.02; 1.32] | |
| | 1 | 205879028 | T | | 0.0658574 | 0.7997 | 1.17 | 3.64E−02 |
| | | | | | | | [1.02; 1.32] | |
| | 1 | 205886998 | A | | 0.0663458 | 0.9673 | 1.18 | 3.18E−02 |
| | | | | | | | [1.03; 1.33] | |
| | 1 | 205888190 | A | | 0.0242082 | 0.1925 | 1.35 | 1.16E−02 |
| | | | | | | | [1.12; 1.58] | |
| | 1 | 205892038 | G | | 0.0657179 | 0.9307 | 1.17 | 3.81E−02 |
| | | | | | | | [1.02; 1.32] | |
| | 1 | 205895594 | T | | 0.0076043 | 0.5694 | 0.54 | 1.40E−02 |
| | | | | | | | [0.04; 1.04] | |

1. An in vitro method for determining that an individual is at risk of developing Alzheimer's disease, which comprises:
determining whether the individual harbours at least one variant allele of a susceptibility gene selected from the apolipoprotein J gene (APOJ) and the complement component receptor 1 gene (CR1);
deducing that if the individual harbours at least one variant allele of the APOJ and/or CR1 gene then the individual is at risk of developing Alzheimer's disease.

2. The method according to claim 1, wherein Alzheimer's disease is late onset Alzheimer's disease.

3. The method according to claim 1, wherein the susceptibility gene is APOJ.

4. The method according to claim 1, comprising:
determining the presence or absence of at least one variation selected from the group consisting of:
a C for the C/T single nucleotide polymorphism (SNP) rs2279590;
a C for the C/T SNP rs11136000; and
a G for the C/G SNP rs9331888;
in the individual; and
deducing that the individual is at risk of developing Alzheimer's disease if said at least one variation is present.

5. The method according to claim 1, comprising:
determining the presence or absence of at least one variation selected from the group consisting of:
a T for the C/T SNP rs10091215;
an A for the T/A SNP rs1073742;
an A for the G/A SNP rs1073743;
a T for the C/T SNP rs10780145;
an A for the A/G SNP rs10866859;
a T for the C/T SNP rs11136000;
a T for the C/T SNP rs11787077;
a T for the C/T SNP rs1532276;
a T for the C/T SNP rs1532277;
a T for the C/T SNP rs1532278;
a G for the A/G SNP rs17057419;
an A for the A/G SNP rs17466684;
a T for the C/T SNP rs1982229;
a C for the G/C SNP rs2070926;
a T for the T/C SNP rs2279590;
a T for the T/C SNP rs2279591;
a C for the C/T SNP rs2582367;
a G for the C/G SNP rs28558661;
a C for the C/G SNP rs35810222;
an A for the A/G SNP rs4236673;
a C for the C/T SNP rs4352801;
a G for the C/G SNP rs4732728;
an A for the A/C SNP rs4732729;
an A for the A/G SNP rs4732732;
a C for the C/T SNP rs484377;
a C for the G/C SNP rs485902;
a T for the G/T SNP rs492638;
a G for the G/T SNP rs495150;
a T for the G/T SNP rs504038;
a C for the C/T SNP rs507341;
a G for the C/G SNP rs518317;
an A for the A/G SNP rs520186;
a G for the A/G SNP rs536332;
a G for the A/G SNP rs538181;
a T for the A/T SNP rs569205;
an A for the A/G SNP rs576748;
a T for the C/T SNP rs6983452;
a C for the C/T SNP rs7828131;
an A for the G/A SNP rs7982;
a C for the A/C SNP rs867230;
a G for the A/G SNP rs9314349;
a C for the T/C SNP rs9331896;
a T for the T/C SNP rs9331908;
an A for the SNP located at nucleotide position 27496798 of human chromosome 8;
a T for the SNP located at nucleotide position 27498182 of human chromosome 8;
a T for the SNP located at nucleotide position 27533395 of human chromosome 8;
a G for the SNP located at nucleotide position 27542063 of human chromosome 8;
a G for the SNP located at nucleotide position 27542086 of human chromosome 8;
an A for the SNP located at nucleotide position 27542087 of human chromosome 8; and
a T for the SNP located at nucleotide position 27542353 of human chromosome 8, in the individual; and
deducing that the individual is at risk of developing Alzheimer's disease if said at least one variation is present.

6. The method according to claim 4, wherein it is deduced that the individual is at risk of developing Alzheimer's disease if it is determined that the individual presents a C for the C/T SNP rs2279590, a C for the C/T SNP rs11136000, and a C or a G for the C/G SNP rs9331888.

7. The method according to claim 5, wherein it is deduced that the individual is at risk of developing Alzheimer's disease if it is determined that the individual presents a T for the C/T SNP rs10091215, an A for the T/A SNP rs1073742, an A for the G/A SNP rs1073743, a T for the C/T SNP rs10780145, an A for the A/G SNP rs10866859, a T for the C/T SNP rs11136000, a T for the C/T SNP rs11787077, a T for the C/T SNP rs1532276, a T for the C/T SNP rs1532277, a T for the C/T SNP rs1532278, a G for the A/G SNP rs17057419, an A for the A/G SNP rs17466684, a T for the C/T SNP rs1982229, a C for the G/C SNP rs2070926, a T for the T/C SNP rs2279590, a T for the T/C SNP rs2279591, a C for the C/T SNP rs2582367, a G for the C/G SNP rs28558661, a C for the C/G SNP rs35810222, an A for the A/G SNP rs4236673, a C for the C/T SNP rs4352801, a G for the C/G SNP rs4732728, an A for the A/C SNP rs4732729, an A for the A/G SNP rs4732732, a C for the C/T SNP rs484377, a C for the G/C SNP rs485902, a T for the G/T SNP rs492638, a G for the G/T SNP rs495150, a T for the G/T SNP rs504038, a C for the C/T SNP rs507341, a G for the C/G SNP rs518317, an A for the A/G SNP rs520186, a G for the A/G SNP rs536332, a G for the A/G SNP rs538181, a T for the A/T SNP rs569205, an A for the A/G SNP rs576748, a T for the C/T SNP rs6983452, a C for the C/T SNP rs7828131, an A for the G/A SNP rs7982, a C for the A/C SNP rs867230, a G for the A/G SNP rs9314349, a C for the T/C SNP rs9331896, a T for the T/C SNP rs9331908, an A for the SNP located at nucleotide position 27496798 of human chromosome 8, a T for the SNP located at nucleotide position 27498182 of human chromosome 8, a T for the SNP located at nucleotide position 27533395 of human chromosome 8, a G for the SNP located at nucleotide position 27542063 of human chromosome 8, a G for the SNP located at nucleotide position 27542086 of human chromosome 8, an A for the SNP located at nucleotide position 27542087 of human chromosome 8 and a T for the SNP located at nucleotide position 27542353 of human chromosome 8.

8. The method according to claim 1, wherein the susceptibility gene is CR1.

9. The method according to claim 1, comprising:
determining the presence or absence of at least one variation selected from the group consisting of:
an A for the A/G SNP rs6656401; and
an A for the A/G SNP rs3818361;
in the individual; and
deducing that the individual is at risk of developing Alzheimer's disease if said at least one variation is present.

10. The method according to claim 9, wherein it is deduced that the individual is at risk of developing Alzheimer's disease if it is determined that the individual presents an A for the A/G SNP rs6656401, and a G or an A for the A/G SNP rs3818361.

11. The method according to claim 1, which comprises further determining whether the individual presents at least one other risk factor for Alzheimer's disease and deducing that the individual is at risk of developing Alzheimer's disease if said individual harbours at least one variant allele of the APOJ and/or the CR1 gene and presents said at least one other risk factor.

12. The method according to claim 1, wherein the at least one other risk factor for Alzheimer's disease is a variant allele of the apolipoprotein E gene.
